(19) United States
(12) Patent Application Publication
(10) Pub. No.: US 2013/0117094 A1
(43) Pub. Date: May 9, 2013

(54) Automated System for Optimizing Retail Savings Using Coupons

(71) Applicants: Megan Jones, Oklahoma City, OK (US); Suzanne Mattson, Portland, OR (US)

(72) Inventors: Megan Jones, Oklahoma City, OK (US); Suzanne Mattson, Portland, OR (US)

(21) Appl. No.: 13/665,507

(22) Filed: Oct. 31, 2012

Related U.S. Application Data
(60) Provisional application No. 61/555,985, filed on Nov. 4, 2011.

(51) Int. Cl. G06Q 30/02

(52) U.S. Cl. 705/14.35

(57) ABSTRACT

A computerized system for optimizing the use of store and manufacturer coupons by consumers. The system maintains a store profile database storing attributes of retail stores, including location and coupon policy rules, a coupon profile database storing the attributes of current and future coupons, a sale profile database storing attributes of sale events at the stores, and a subscriber profile database storing identifiers of stores preferred by the subscriber, subscriber preferences, and the like. A matchup process executed by the system interrogates the databases to identify matches among stores, coupons, and sale events, and provides the subscriber with a list of those matches, from which the subscriber can enter shopping list inputs that identify items that the subscriber wants to purchase, including coupons possessed by the subscriber. A transactionator process executed by the system uses the shopping list inputs to create suggested transactions for the subscriber that minimizes out-of-pocket cost, maximizes savings, or maximizes the value of items purchased within a spending limit.

### CROSS-REFERENCE TO RELATED APPLICATIONS

This application claims priority, under 35 U.S.C. §119(e), of Provisional Application No. 61/555,985, filed Nov. 4, 2011, and which is incorporated herein by this reference.

### STATEMENT REGARDING FEDERALLY SPONSORED RESEARCH OR DEVELOPMENT

Not applicable.

### BACKGROUND OF THE INVENTION

This invention is in the field of retail shopping assistant systems. Embodiments of this invention are directed to an interactive computer system and method of operating the same to assist retail shoppers in optimizing expenditures and savings.

An age-old marketing approach adopted by manufacturers of retail goods and retailers alike is the issuance of coupons to potential customers. In the case of manufacturer coupons, the consumer presents the coupon at the retailer point-of-purchase, to receive a discount or other incentive for purchasing a product with the coupon. The retailer is reimbursed by the manufacturer for the discount or other incentive. Retail stores also issue coupons themselves (i.e., “store coupons”), which the consumer similarly redeems at the point-of-purchase.

The particular discount or incentive offered by the coupon can be stated in terms of a “price off” (e.g., $1.00 off the purchase price), a percentage discount, or a buy-X-items-get-Y-items (“BOGO ) type of incentive. Many retailers also offer some multiple of the stated discount on manufacturers' coupons (e.g., “double coupons”). Some retailers provide the consumer with reward coupons (e.g., cash back, points earned in a store points program), or discount coupons for use in a next purchase at the store; these coupons are often generated at the point-of-purchase, based on the particular items or quantities then being purchased by the consumer. Some retailers offer discounts to match the lowest competitor price for the same item. Some retailers (and a few manufacturers) also offer customer reward programs, in which the consumer “earns” rewards in the form of cash rebates etc. upon purchasing a stated number of value of products from the manufacturer or retailer.

The purposes of discount coupons, incentive programs, and the like are many. In a basic sense, discount and incentive coupons are used to entice customers to buy a product, or shop at a particular retailer, in order to make the customer aware of the benefits or quality of the product, and on the hope that the customer will buy other products from the same manufacturer or at the same retailer. In addition, the manufacturer or retailer, as the case may be, can learn about the efficacy of various advertising vehicles (e.g., print versus email advertisements) in convincing the consuming public to purchase a particular product or shop at a particular store.

In addition, as well known by all consumers, stores often have “sales”, during which the prices of selected items are reduced, with the hope of increasing store traffic and revenue. Some stores tend to offer “sale prices” for limited times on specific items, with different items going on sale after previous sales end.

It is of course to the consumer's benefit to optimize their shopping (i.e., maximizing savings and reducing out-of-pocket expenditures) by taking advantage of discount and incentive coupons, coupon enhancements (“double coupons”, “upgraded” coupons, and the like), store sales, rebate coupons, cash back or other reward programs, etc. Recent media reports have highlighted individual shoppers who have achieved tremendous savings by combining these offers. However, the number of combinations of these offers, especially when comparing those combinations among competitive stores in the shopper's vicinity, makes the process difficult even if the consumer is aware of current sales and all of the requirements and restrictions on the various coupons. Especially as sales and coupon policies come and go over time, it is an especially time-consuming effort to analyze those combinations, in addition to keeping track of the items that are actually needed by the household.

By way of background, online coupon services and tools are known in the art. One known smartphone “app” includes a bar code scan function for scanning the UPC code of products by a shopper when at a grocery store; in response to a scanned UPC code, the server matches the scanned item against a database of instant coupons associated with the manufacturer of that product, associates applicable coupons with the customer's store rewards or savings card, and causes the cash register at the store to redeem the instant coupons upon the shopper swiping the rewards or savings card at checkout.

Other conventional approaches to online coupon services include “couponing” blogs or services that publish manually-identified product-coupon matches. These conventional approaches are static, in the sense that a change in store coupon policies require re-evaluation of the previously identified matches, typically by way of human intervention. Customers manually browse or search the published matches to identify the items they wish to purchase; can sort the data by category, coupon source, or store; and can print a shopping list with reminders to bring particular coupons. Online tracking of spending and coupon savings is also provided by these conventional services.

### BRIEF SUMMARY OF THE INVENTION

Embodiments of this invention provide an interactive automated system and method of operating the same to provide consumers with maximized savings and minimized cost in purchasing retail products.

Embodiments of this invention provide such a system and method in which the consumer generates a plan for optimizing coupon savings, sales events, and rewards, by structuring transactions at a particular retailer.

Embodiments of this invention provide such a system and method in which the consumer can track savings and rebate rewards over time.

Embodiments of this invention provide such a system and method in which the consumer can adjust the shopping plan upon learning that a desired item is out of stock at the store, or to take advantage of a current “rain check” for a previously out-of-stock item.

Other objects and advantages provided by embodiments of this invention will be apparent to those of ordinary skill in the art having reference to the following specification together with its drawings.

Embodiments of this invention can be realized by way of an interactive computer application, for example realized by way of a web application or other Internet-accessible facility resident at a server, and a method of operating the same. The system includes one or more memory resources in which various databases are maintained. A subscriber profile data base stores, for each subscriber, his or her preferred stores and locations. A coupon profile database stores attribute data for currently active coupons, such attribute data including, for each coupon, at least the duration of the coupon and a face value (e.g. “cents off”, “% off”, a sale price, as additional items at a reduced price or free, etc.). A store profile data base stores data specifying a number of retail stores with associated attributes, including the location of the store and also that store's coupon policies; and a sale profile database stores data identifying the attributes of sale events, including the retail store locations for those sale events, and one or more sale items with their sale prices, or cash-back rewards. The system and method execute a matchup application to analyze sales and coupons to identify combinations of coupons and sales that are currently available at each retail store, taking into account the effect of coupon policies at the store, and displays, to each subscriber, those matchups for the preferred retail stores for that subscriber. In response to the selection of a shopping list of desired items from the displayed matchups, the system and method execute an application that arranges the desired items into one or more suggested shopping transactions, producing a customized shopping plan for the consumer that includes the items to be purchased in one or more transactions at a particular retailer in order to minimize out of pocket cost, maximize savings, or to otherwise optimize the cost and value of the purchases.

### BRIEF DESCRIPTION OF THE SEVERAL VIEWS OF THE DRAWING

FIG. 1 is an electrical diagram, in block form, of a networked computer system according to embodiments of the invention.

FIG. 2 is a flow diagram illustrating the overall operation of the system of FIG. 1 in carrying out processes according to embodiments of the invention.

FIG. 3 is a flow diagram illustrating the operation of the matchup process executed by the system of FIG. 1 according to the operation of FIG. 2, according to embodiments of the invention.

FIG. 4 is a flow diagram illustrating the operation of a process for evaluating buy-one-get-one sales and coupons within the matchup process of FIG. 3, according to embodiments of the invention.

FIG. 5 is a flow diagram illustrating the detailed operation of a process for evaluating buy-one-get-one sales and coupons within the matchup process of FIG. 3, according to embodiments of the invention.

FIG. 6 is a flow diagram illustrating the operation of a process for evaluating buy-one-get-one coupons in the absence of a buy-one-get-one-sale within the matchup process of FIG. 3, according to embodiments of the invention.

FIGS. 7a and 7b are flow diagrams illustrating the operation of a process for evaluating multiplying of coupons within the matchup process of FIG. 3, according to embodiments of the invention.

FIG. 8 is a flow diagram illustrating the operation of a process for evaluating coupon upgrade policies within the matchup process of FIG. 3, according to embodiments of the invention

FIG. 9 is a flow diagram illustrating the operation of a transactionator process within a portion of the operation of FIG. 2, according to embodiments of the invention.

FIGS. 10a and 10b constitute a flow diagram illustrating the operation of the transactionator process executed by the system of FIG. 1 according to the operation of FIG. 2, according to embodiments of the invention.

FIGS. 11a and 11b are flow diagrams illustrating the operation of coupon doubling processes useful in connection with the transactionator process of FIGS. 10a and 10b, according to embodiments of the invention.

### DETAILED DESCRIPTION OF THE INVENTION

This invention will be described in connection with one or more of its embodiments, namely as implemented into a computer system operating over a wide-area network such as the Internet, with web applications executed by the user in an interactive manner. However, it is contemplated that embodiments of the invention may be realized in other computer and system architectures, including by way of a client computer application or in a stand-alone automated system. Accordingly, it is to be understood that the following description is provided by way of example only, and is not intended to limit the true scope of this invention as claimed.

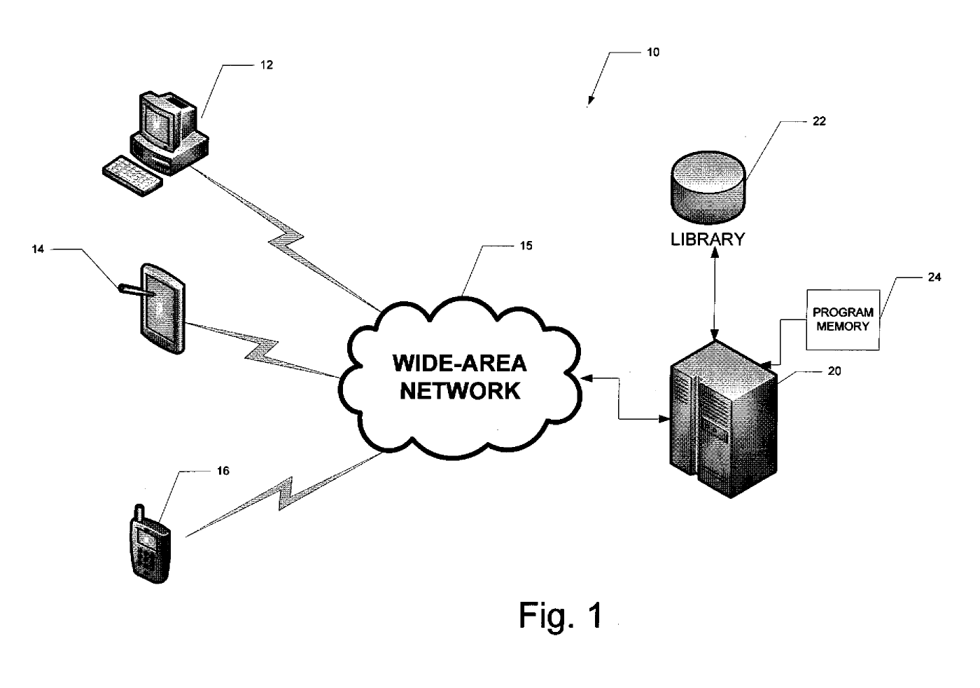

FIG. 1 illustrates the construction of optimization system 10 according to an example of an embodiment of the invention, which performs the operations described in this specification to optimize the benefit of shopping incentives for consumers. In this example, optimization system 10 is as realized by way of a computer system including various client systems 12, 14, 16 which are in communication with server 20 by way of a wide-area network (WAN) 15. For purposes of this description, WAN 15 will correspond to the Internet; alternatively, WAN 15 may be some sort of private or other controlled-access network. The particular architecture and construction of a computer system useful in connection with this invention can vary widely. For example, optimization system 10 may be realized by a single physical computer, such as a conventional workstation or personal computer, or alternatively by a computer system implemented in a distributed manner over multiple physical computers. Accordingly, the generalized architecture illustrated in FIG. 1 is provided merely by way of example.

As shown in FIG. 1 and as mentioned above, optimization system 10 includes one or more client systems 12, 14, and 16, and server 20. In this example, these client systems include workstation 12, constructed as a conventional personal computer system (of either the laptop or desktop/tower variety), which interfaces to wide-area network 15 via the appropriate communications facilities such as a local area network (if present) and router (not shown). In this embodiment of the invention, server 20 is a computer system, of a conventional architecture similar, in a general sense, to that of workstation 11, and as such includes one or more central processing units, system buses, and memory resources, network interface functions, and the like. Tablet computer 14 and smartphone 16 are other types of client systems that are contemplated to be particularly useful in connection with embodiments of this invention. As well-known in the art, tablet computer 14 and smartphone 16 typically access WAN 15 wirelessly, either by way of a wireless link to a local-area network that itself connects to WAN 15, or by way of a cellular telephone communications link.

Server 20 is contemplated to be typically constructed as one or more computer systems for supporting the automated optimization functions described in this specification in connection with the embodiments of the invention. In the example described in this specification, server 20 performs its functions by executing one or more computer programs stored in program memory 24, which is a computer-readable medium storing executable computer program instructions according to which the operations described in this specification are carried out by optimization system 10. In this embodiment of the invention, these computer program instructions are executed by server 20, in the form of a “web-based” application, upon input data communicated from client systems 12, 14, 16 and databases stored in data library 22, to create output data and results that are communicated to the appropriate client system 12, 14, 16 for display or other output in a form useful to the human user. Data library 22, available to server 20, stores the various databases called upon in the execution of processes to be described in this specification. Data library 22 may be directly coupled to server 20, or may reside on another local area network, or may alternatively be accessible via WAN 15 or another wide area network. It is contemplated that data library 22 may also be accessible to other associated computers in the overall network.

Of course, the particular memory resource or location at which data library 22 and program memory 24 physically reside can be implemented in various locations in optimization system 10. For example, data and program instructions may be stored in local memory resources within client systems 12, 14, 16, within server 20, or in network-accessible memory resources to these functions. In addition, each of these data and program memory resources can itself be distributed among multiple locations, as known in the art. It is contemplated that those skilled in the art will be readily able to implement the storage and retrieval of the applicable measurements, models, and other information useful in connection with this embodiment of the invention, in a suitable manner for each particular application.

As mentioned above, and according to embodiments of the invention, program memory 24 stores computer instructions executable by server 20 to carry out the functions described in this specification, by way of which the functions relating to optimization of retail savings are carried out. These computer instructions may be in the form of one or more executable programs, or in the form of source code or higher-level code from which one or more executable programs are derived, assembled, interpreted or compiled. Any one of a number of computer languages or protocols may be used, depending on the manner in which the desired operations are to be carried out. For example, these computer instructions may be written in a conventional high level language, either as a conventional linear computer program or arranged for execution in an object-oriented manner. These instructions may also be embedded within a higher-level application. Alternatively, these computer-executable software instructions may be resident elsewhere on the local area network or wide area network, or downloadable from higher-level servers or locations, by way of encoded information on an electromagnetic carrier signal via some network interface or input/output device. The computer-executable software instructions may have originally been stored on a removable or other non-volatile computer-readable storage medium (e.g., a DVD disk, flash memory, or the like), or downloadable as encoded information on an electromagnetic carrier signal, in the form of a software package from which the computer-executable software instructions were installed by prediction system 10 in the conventional manner for software installation.

In particular, it is contemplated that the software of optimization system 10 may be beneficially implemented by way of a “web application”, in which the executable software resides and is executed on server 20 in response to commands and input data forwarded over WAN 15 from one of client systems 12, 14, 16. In that implementation, the bulk of the software functionality resides and is executed on server 20, with the communications links established by WAN 15 and the corresponding communications facilities to client systems 12, 14, 16 defining the protocol by which the various physical computers communicate with one another to carry out those functions. In such an implementation, the manner in which the subscriber interactively operates optimization system 10 may be by way of a tablet or smartphone “app”. In any of these or other alternative computer architectures, optimization system 10 executes its software to configure and customize shopping transactions for a subscriber, based on selections made by that subscriber in advance, and interactively via one of client systems 12, 14, 16. It is contemplated that those skilled in the art having reference to this specification will be readily able to implement the appropriate computer software programs and architecture for such a web application, or in such other software architecture as desired, without undue experimentation.

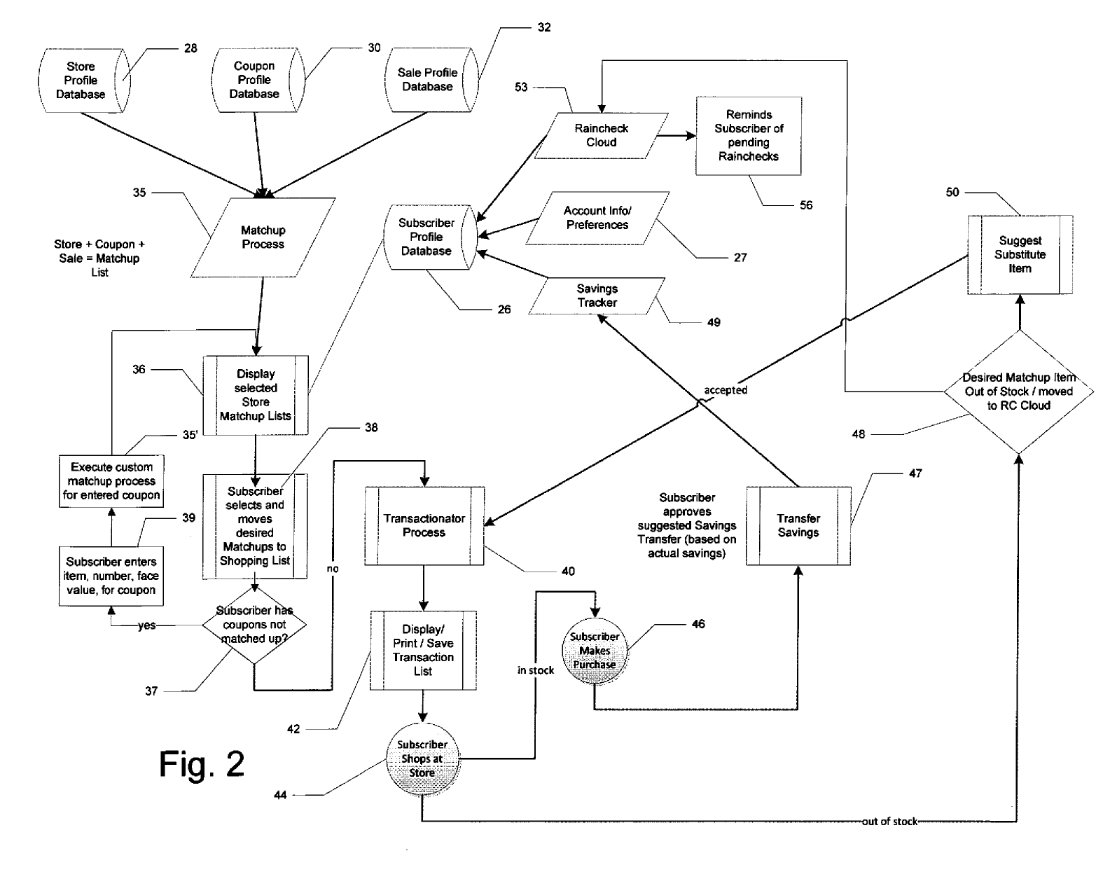

Referring now to FIG. 2, an example of the overall method of optimizing consumer savings through the use of coupons, as carried out according to embodiments of this invention, will be described. Of course, variations and alternatives to this implementation will be apparent to those skilled in the art having reference to this specification; it is contemplated that those variations and alternatives are within the scope of this invention.

Data library 22 of optimization system 10 retains several databases that are useful in this optimization method. One such database is subscriber profile database 26, which stores information regarding each user or subscriber, as entered by that subscriber upon signing up for the service provided by optimization system 10 according to embodiments of this invention. An example of the data retained in subscriber profile database 26 for each subscriber includes account information and preferences file 27, containing such attributes as:
Name
Email address
Password
Billing information (e.g., online account, credit card)
Preferred stores to follow
   For those stores offering an additional % off after a customer reaches a spending goal, that % off is also retained for the subscriber in database 26
Savings Goal/Tracker (incl. name, description, savings goal, desired timeframe for reaching the goal, photo, etc.)
Roll/No Roll preference
Other preferences (e.g., types of items that the subscriber is not interested in)
   Store profile database 28 is also stored within data library of optimization system 10, and stores information regarding each store to be analyzed. According to embodiments of this invention, each location of a “chain” store will have a separate entry in store profile database 28, because different locations may offer different sales or store coupons, or may treat manufacturer coupons differently from one another; of course, the various locations of such a chain store will share many common attributes. An example of the data stored for each store in database 28 includes:
Store name
Store location/region
Store cycle
Club Card required?
Multiple transactions per visit/day permitted?
Double manufacturer coupons (MFC)?
Double MFC indicated as “do-not-double” (DND)?
Upgrade MFC?
Upgrade MFC indicated as DND?
Offer store coupons (STC)?
Double STC?
Double STC indicated as DND?
Upgrade STC?
Upgrade STC indicated as DND?
Accept competitor coupons?
Can use coupons against a free item?
Offer rainchecks for coupon/sale items?
Reward card ($BC)? (i.e., cash rebates or points for purchases, usable in a later transaction at the store)
$/$$ transaction coupons? (e.g., $20 off purchases of over $100)
Must item count equal coupon count?
Rebate program?
Membership % off.
Gas/Gift card loyalty program
“Buy-get” (BOGO) policies:
   Buy-one-get-one-free (BOGOF)+BOGOF=2 free items, 2 at retail?
   Buy-one-get-one-half price (BOGO.5)+BOGOF=2 items for half price, 2 at retail?
   BOGO.5+BOGO.5=2 items for half price, 2 at retail?
   BOGO.5+buy-two-get-one-free (B2G1F)=3 items for half price, 2 at retail?
   BOGOF+B2G1F=B1G2F (2 free items, one at retail)?
   B2G1F+B2G1F=BOGOF*3=3 free items, 3 at retail?
Parent or child with other store profiles; if so, are attributes inherited?
   For purposes of this description, the acronym “BOGO” refers to any type of “buy-get” coupon, sale, policy, or other offer, including such offers as buy-X-items-get-Y-items, buy-X-items-get-Y-items-at-reduced-price, etc., and may involve such variations as different products (e.g., buy one of item X and get one of item Y), different manufacturers, and the like. In the above list, the “?” indicates that the profile stores a yes/no flag or other value indicating whether the profile has or permits the corresponding attribute. Data library 22 also includes coupon profile database 30, which stores the data pertaining to the identity and attributes of manufacturer coupons (MTC) and store coupons (STC). Manufacturer coupons include coupons that are issued by the manufacturer of the subject items in print advertising, direct mail flyers, advertisements distributed by email or otherwise over the Internet, by direct handout to consumers, and the like. Store coupons are coupons issued by the retailers, either by the overall retail chain including the local stores, or by individual stores in particular markets; these coupons are distributed in similar ways as are manufacturer coupons, and also as “checkout” coupons generated at the point-of-sale terminal of individual stores upon payment for a transaction, for use in a later transaction. An example of the data stored for each manufacturer coupon in coupon profile database 30 includes:
Manufacturer
Item name, size, count
Exclusions
Original Face Value (e.g., indicated by “cents off”, % off, or a reduced price)
Coupon denominator
Expiration date
Origin or source
DND?
Number of items required for execution
   An example of the data stored for each store coupon in coupon profile database 30 includes:
Store name, location
Manufacturer
Item name, size, count
Exclusions
Original Face Value (e.g., indicated by “cents off”, % off, or a reduced price)
Coupon denominator
Expiration date
Origin or source
DND?
Number of items required for execution
   It is further contemplated that the precision of information stored in coupon profile database 30 pertaining to manufacturer coupons may extend well beyond that information conventionally contained within the UPC bar codes printed on those coupons. For example, conventional manufacturer coupons may specify that a coupon is only applicable to a certain flavor, size, or variety of a product; however, the UPC may only convey a product “family” code that also includes flavors, sizes, and varieties beyond those for which the coupon is intended. Accordingly, it is contemplated that coupon profile database 30 may include higher precision information than that conveyed by the UPC bar codes and other generic information; the resulting matchups identified by optimization system 10 according to embodiments of this invention can therefore be more accurate, with the resulting transactions being more likely to successfully optimize the benefit value for the subscriber when purchasing the matchup items. For example, the coupon attributes stored in coupon profile database 30 may include additional attributes as brand of the item, sub-brand of the item, variety (e.g., flavor, “deluxe” version, etc.), size of the item (e.g., lbs., oz., etc.), and the like.

Data library 22 also includes sale profile database 32, which stores the identity and attributes of current and future sale events at stores of interest, and for which data are stored in store profile database 28. An example of the data stored for each sale event in sale profile database 32 includes:
Store and location
Manufacturer
Item
Deal type (e.g., $ off; % off; buy-get, etc.)
Deal value, namely the value of the deal indicated by “deal type” (e.g., price reduction, price, how many free for how many purchased, etc.)
Number of items required for execution (e.g., X items for $Y)
$ amount of transaction required for execution (e.g., purchases over $75)
Cash back reward coupon value
Rebate amount/face value
Reward points value (for points-based store rewards)
BOGOF
BOGO.5
B2G1F
Club card required?

Of course, the particular data stored in each of databases 26, 28, 30, 32 may vary from the examples given above. It is contemplated that those skilled in the art having reference to this specification can readily define the particular attributes of interest for particular implementations. In addition, the data stored in each of databases 28, 30, 32 may be entered manually, or may be downloaded from existing databases (publicly available sources, subscription-based sources, etc.). In particular, it is contemplated that coupon profile database 30 and sale profile database 32 will change most frequently. The data stored in subscriber profile database 26 will typically be updated or modified by the subscriber as desired or as necessary.

According to embodiments of this invention, combinations of coupons with sales, coupons with enhancements according to store policies, coupons with cash back or other rebates or rewards, and combinations among all of these consumer benefits, are of interest to the subscriber, and are identified by optimization system 20 in order to optimize expenditures by the consumer. According to embodiments of this invention, upon entry or update of data in store profile database 28, coupon profile database 30, and sale profile database 32, optimization system 10 executes matchup process 35, by way of which matches among products, coupons, sales, and store enhancements are identified. It is contemplated that matchup process 35 will generate these matchups without regard to specific subscribers, i.e., without referring to customer profiles, and as such may be executed by server 20 in a continuous, periodic, or background manner. Details regarding some of the sub-processes and sub-policies carried out by optimization system 10 according to embodiments of this invention will be described in detail below. It is contemplated that matchup process 35 may be performed by optimization system 10, for example at server 20, in a periodic or other automated manner, without user prompting; alternatively, or in addition, it is contemplated a subscriber may initiate a specialized instance of matchup process 35, for example as applied to a subset of items or store locations, by logging into optimization system 10 from a client system 12, 14, 16 and initiating the process. In this regard, optimization system 10 can readily apply recent updates to store profile information into the overall optimization. For example, upon receiving data indicative of an update to coupon rules at a particular retail store or chain of stores, optimization system 10 can then repeat matchup process 35 to apply those new rules to the active coupons, current or future sale events, and the like.

Upon completion of an instance of matchup process 35, optimization system 10 generates lists of specific matchups among products, coupons, sales, etc., for display to one or more subscribers in process 36. According to an embodiment of the invention, these matchup lists are subsets of the matchups identified in matchup process 35, but restricted when presented to an individual subscriber in process 36, according to the preferences in that subscriber's entry in subscriber profile database 26. The preferences pertinent to matchup display process 36 include the subscriber's address or other geographical preferences, and preferred stores that the subscriber has selected. Each item in the matchup list displayed to a subscriber includes a particular item, coupons currently in force that apply to that item, current or future sales on that item at particular stores, the number of that item required for the savings, and the like. The matchup lists presented in process 36 may be ordered in various ways, including sorted by store (i.e., all matchups for a particular store grouped together), sorted by item (perhaps into categories, to allow for easy shopping), sorted by maximum combined savings, or the like. These matchup lists will be presented by optimization system 10 at the display output of the client system 12, 14, 16 at which the user is currently logged in.

When presented with the matchup lists from process 36, the number of items and corresponding matchups will be a relatively comprehensive list, including of course items that the subscriber is not interested in purchasing, and also items for which the subscriber does not possess the corresponding coupon. In process 38, the subscriber operates client system 12, 14, 16 interactively with server 20 to provide shopping list inputs by way of which items are selected from the matchup list (including the item, the coupon, and the particular store location if specified) that the subscriber wants to purchase, and for which the subscriber possesses the corresponding coupon. In one embodiment of the invention, the subscriber makes the interactive selection by “dragging” the item to a personalized shopping list created at client system 12, 14, 16 by a software function. Of course, other selection techniques may alternatively be applied. It is contemplated that the subscriber will typically select multiple items, perhaps from multiple stores, in order to build a list for a particular shopping trip, by way of process 38. For example, the shopping list inputs may be communicated by the subscriber indicating a spending limit (either at a single store, or without restriction to particular stores), and the types or classes of items that the subscriber wishes to purchase (e.g., cleaning products, breakfast cereals, etc.).

An optional embodiment of the invention contemplates that the subscriber may possess coupons that are not an element of coupon profile database 30, such that matchup process 35 did not consider those coupons in the matchup lists displayed in process 36. In this embodiment of the invention, decision 37 is then executed by optimization system 10, to determine whether the subscriber has indicated (for example by way of a GUI button or box clicked by the subscriber) that he or she possesses a coupon not considered in the displayed matchup lists. If so (decision 37 is “yes”), optimization system 10 prompts the user to enter data concerning attributes of those coupons, including the item to which the coupon pertains, its manufacturer, the coupon face value, expiration date, whether the coupon is a manufacturer or store coupon, and other attributes similar to those stored for coupons in coupon profile database. Optimization system 10 may coupon profile database 30 with this information by storing a new entry corresponding to those inputs; alternatively, this “custom” coupon may be considered simply for this subscriber, or for this instance of the process. Once receiving the coupon attribute data, optimization system 10 then executes custom matchup process 35′, by way of which matchup process 35 is carried out for this newly entered custom coupon, relative to preferred stores for the subscriber entering this new coupon, and repeats display process 36 to update the displayed matchup list. The subscriber can then add one or more items associated with this custom coupon to the shopping list, in a repeated instance of process 38, so that this coupon can be properly considered in the overall optimization.

Following completion of the shopping list (e.g., decision 37 is “no”), process 40 of this embodiment of the invention corresponds to the execution of a “transactionator” software module in optimization system 10, for example as executed by server 20 in response to a subscriber request made at the appropriate client system 12, 14, 16 at which the subscriber is logged in. As will be described below in further detail, transactionator process 40 arranges the matches that are selected by the subscriber in process 38 into one or more transactions, with the number and composition of those transactions determined by optimization system 10 in transactionator process 40 to optimize one or more benefit values. According to embodiments of this invention, the optimized benefit value may be one or more of minimum out-of-pocket cost, maximum savings (e.g., relative to retail price), maximum retail value of the items purchased within a specified spending limit, and the like. According to an embodiment of the invention, the subscriber can select the particular benefit value to be optimized in transactionator process 40. In any event, the optimization of the benefit value will typically take into account not only the matched coupons and sales, but other enhancements such as rebates, cash back or store points rewards, store coupons issued at checkout, or other rewards that can be used to advantage in a subsequent transaction at the store.

Upon completion of transactionator process 40, optimization system 10 outputs the results to the subscriber in process 42, using any one or more of a number of ways, depending on the nature of the particular client system 12, 14, 16 through which the subscriber is logged in. For example, if the subscriber is at client system 12 in the form of a workstation, it is contemplated that the transaction list can be displayed and then printed on request at a local or network printer. For wireless client systems in the form of tablet computer 14 or smartphone 16 (e.g., via an “app” executed at those client systems 14, 16), it is contemplated that the transaction list will be displayed by way of an interactive list, so that the subscriber can access the transaction list while at the store, and provide additional inputs to a repeated instance of transactionator process 40 depending on the results of the shopping trip.

Process 44 represents the subscriber going to the store (either physically, or perhaps online) and shopping for the items on the transaction list. Each item that is in stock at the store is then purchased by the subscriber (if desired) in process 46. Either if client systems 14, 16 are used by the subscriber while shopping at the store, or upon the subscriber returning to client system 12, 14, 16 upon returning home or at another location, the client can interactively indicate those items on the transaction list that are purchased. According to some embodiments of the invention, data library 22 can store savings tracker data 49 associated with the subscriber via subscriber profile database 26. In process 47 in such an implementation, optimization system 10 updates savings tracker data 49 in response to the subscriber interactively indicating the savings obtained for the item in the current transaction.

For those items that the subscriber finds at the store to be out of stock, the subscriber forwards an indication accordingly to optimization system 10 either on-site at the store or later, upon return from the store, via the appropriate client system 12, 14, 16. Of course, for purposes of immediate response by optimization system 10 to the out-of-stock situation, interactive communication between wireless client system 14, 16 is preferred. Especially in that case, optimization system 10 responds to the out-of-stock indication for an item by executing process 48. One result of process 48 is an interactive suggestion of a substitute item to the subscriber which, if accepted by the subscriber as indicated in an interactive response, causes another instance of transactionator process 40 to be executed, which can generate a new transaction list for display, printing, or saving in process 42. Conversely, if no acceptable substitute item is suggested as a result of process 48, optimization system 10 can update “raincheck cloud” 52, which is a store in memory of any rainchecks available and issued by the store in the event that a sale or coupon item is out of stock; such rainchecks, as known in the industry, provide the consumer with an extension of the coupon or sale terms until such time as the item is again in stock. Raincheck cloud 53 is stored for the subscriber in connection with subscriber profile database 26, with its contents available for use in generation of another iteration of the personalized matchup lists via process 36, followed by a new instance of transactionator process 40. Optimization system 10 can also remind the subscriber of pending rainchecks, via process 56, for example by way of a frame in a website portal for the overall process, by email, or the like.

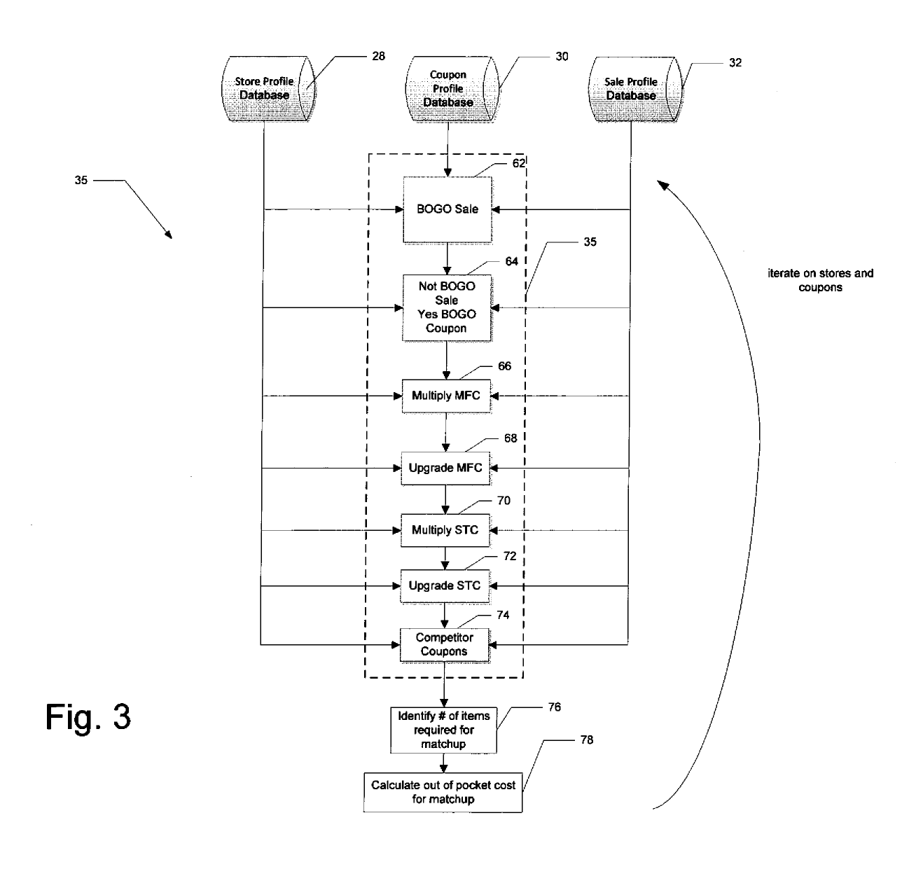

Referring now to FIGS. 3 through 8, the detailed operation of optimization system 10 in executing matchup process 35 will now be described. As evident from the foregoing description, various types of matchups among items, coupons, sales, rebates or other incentives, and the like are possible; in addition, the particular policies of stores or manufacturers affect the overall total available savings or out of pocket price. As such, matchup process 35 is arranged to analyze combinations of those factors in arriving at a matchup list from which the displayed matchups for a customer may be derived.

FIG. 3 is an overall flow diagram illustrating the general flow of matchup process 35. In some embodiments of this invention, matchup process 35 is arranged as a sequence of individual matchup analyses; while there may be some benefit in performing one such analysis prior to another in particular implementations, it is contemplated that the order in which these various analyses are performed can vary from that shown in FIG. 3; in some implementations, later analyses may benefit from the results of previous analyses. In addition, it is contemplated that additional or even fewer analyses may be executed in matchup process 35, depending on the nature of particular coupons, stores, items, or the extent to which optimization system 10 undertakes the analysis. As mentioned above, matchup process 35 can be carried out independently from user interaction, and as such can be executed in the background, overnight or during off hours, or on a somewhat continuous schedule; only the then-completed results are displayed to subscribers at any given time.

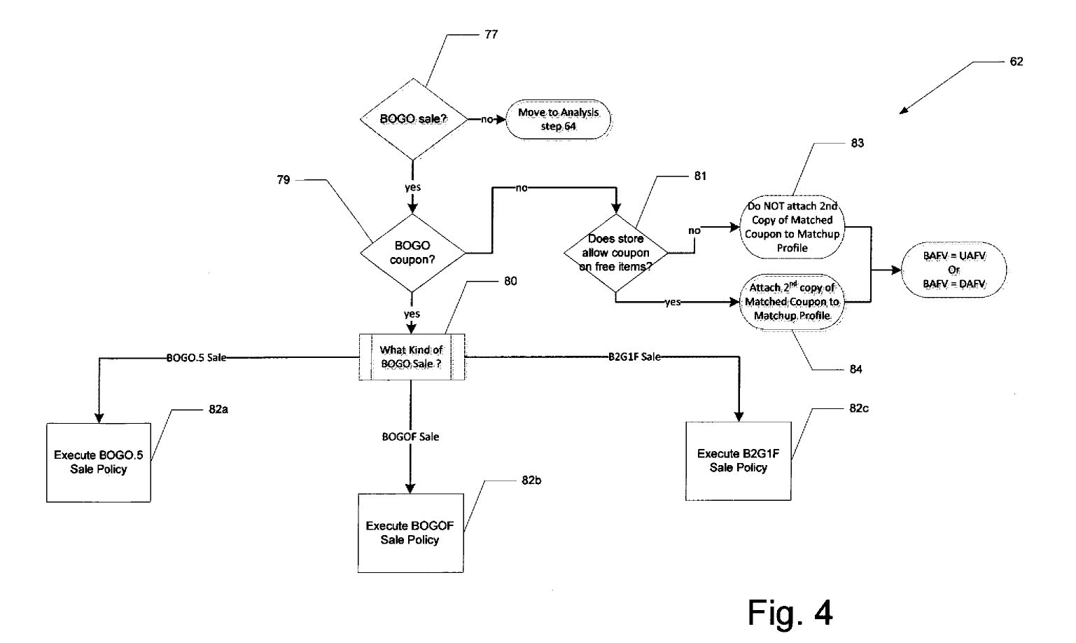

In the example of FIG. 3, each of the matchup analyses rely on information retrieved from store profile database 28, coupon profile database 30, and sale profile database 32, each of which may be stored in data library 22 of optimization system 10 as described above. In this example, matchup process 35 begins with buy-one-get-one (BOGO) sale analysis 62, in which optimization system 10 analyzes the situation in which the retail store under analysis is offering some type of BOGO sale, and for which a coupon is available for a particular item (some items, of course, having multiple coupons in effect at any given time) in combination with the sale. FIG. 4 illustrates the operation of BOGO sale analysis 62, beginning with decision 77 in which optimization system 10 determines whether a BOGO sale is currently offered by the store; if not (decision 77 is “no”), control passes to the next analysis process (process 64) in matchup process 35.

If a BOGO sale is currently offered (decision 77 is “yes”), then decision 79 is carried out to determine whether the coupon undergoing matchup analysis is a BOGO coupon of some type. If not (decision 79 is “no), decision 81 is executed to determine whether the store allows the use of another type of coupon on free items. If so (decision 81 is “yes”), a second copy of the matched coupon is attached to the matchup profile in process 83; if not (decision 81 is “no”) then no such copy is attached (process 84). Optimization system 10 then computes a BOGO Adjusted Face Value (“BAFV”) as equal to an Upgraded Adjusted Face Value (“UAFV”) or a Doubled Adjusted Face Value (“DAFV”), based on the store policy reflected in decision 81.

Referring back to FIG. 4, if the coupon of interest to the current instance of matchup process 35 is a BOGO coupon (decision 79 is “yes”), process 80 is then executed to determine what type of BOGO sale is currently offered by the store of interest, as that will affect the value gained by the matchup of a BOGO coupon and a BOGO sale. According to this example, the types of BOGO sales offered include “buy-one-get-one-free” (“BOGOF”), “buy-one-get-one-at-half-price” (“BOGO.5”), and “buy-two-get-one-free” (“B2G1F”).

In connection with the particular operations and flow diagrams shown in the Figures and described herein, various acronyms are used. The following is a list of those acronyms, along with their definitions as used in connection with this specification:
#FI # of Filler Items Required for Transaction
FIN# Final # of Items Required for Matchup
#IM # of Items in Matchup
#IT # of Items in Transaction
#RIMC # of Items Required by Manufacturer Coupon
#RISC # of Items Required by Store Coupon
#RISS # of Items Required by Store Sale
$/$$ $ off of $$ Purchase Coupon/Sale (i.e. $5 off of a $35 Purchase)
$BC or CBC Cash Back, Points, or other Reward Coupon
$RMC $ Required by Manufacturer Coupon (total purchase amount)
$RSC $ Required by Store Coupon (total purchase amount)
$RSS $ Required by Store Sale (total purchase amount)
AFV Adjusted Face Value
B2G1F-C Buy Two Get One Free Coupon
B2G1F-S Buy Two Get One Free Sale
BOGO.5-C Buy One Get One 50% Off Coupon
BOGO.5-S Buy One Get One 50% Off Sale
BOGOF-C Buy One Get One Free Coupon
BOGOF-S Buy One Get One Free Sale
CDE Coupon Denominator (e.g., the “1” in a $2/1 coupon)
CF CellFire Coupon
DND Do Not Double
ETS Excludes Trial/Travel Size (coupon restriction)
EXP Expiration Date
IPC Internet/Printable Coupon
ITM Item
Matchup The combination of a sale item and eligible coupons that produces a greater savings than the sale or coupon(s) alone
MFC Manufacturer Coupon
MFR Manufacturer
MMK Money Maker Transaction
MSVG Matchup Savings
MOOP Matchup Out Of Pocket
MUN Matchup Name
MUP Matchup Profile (all info re: a matchup)
OFV Original Face Value
OOP Out of Pocket
RFV Rebate Amount/Face Value
RNC Raincheck
Roll Using $BC from one transaction against the next transaction
RP Red Plum
SLP Sale Price
SOU Source
SS Smart Source
STC Store Coupon
STO Store Name
SVG Savings Amount
T#C Total # of Coupons in a Transaction
T#I Total # of Items in Transaction
TSVG Transaction Savings
TOOP Transaction Out Of Pocket Amount
TRC Transaction Coupon
TX1, TX2, TX3 . . . Transaction #1, #2, #3 . . .
FP Filler Price
MRE Matchup Retail amount
DAFV Double Adjusted Face Value
FVL Face Value Limit
UAFV Upgrade Adjusted Face Value
FVTP Face Value Top Parameter
FVBP Face Value Bottom Parameter
BAFV BOGO Adjusted Face Value
OSLP Original Sales Price
BSLP BOGO Adjusted Sales Price
   It is contemplated that those skilled in the art, having reference to this specification, will readily comprehend the nature of these terms, and can readily incorporate these and similar coupon-related functions into their particular implementation of this invention, without undue experimentation.

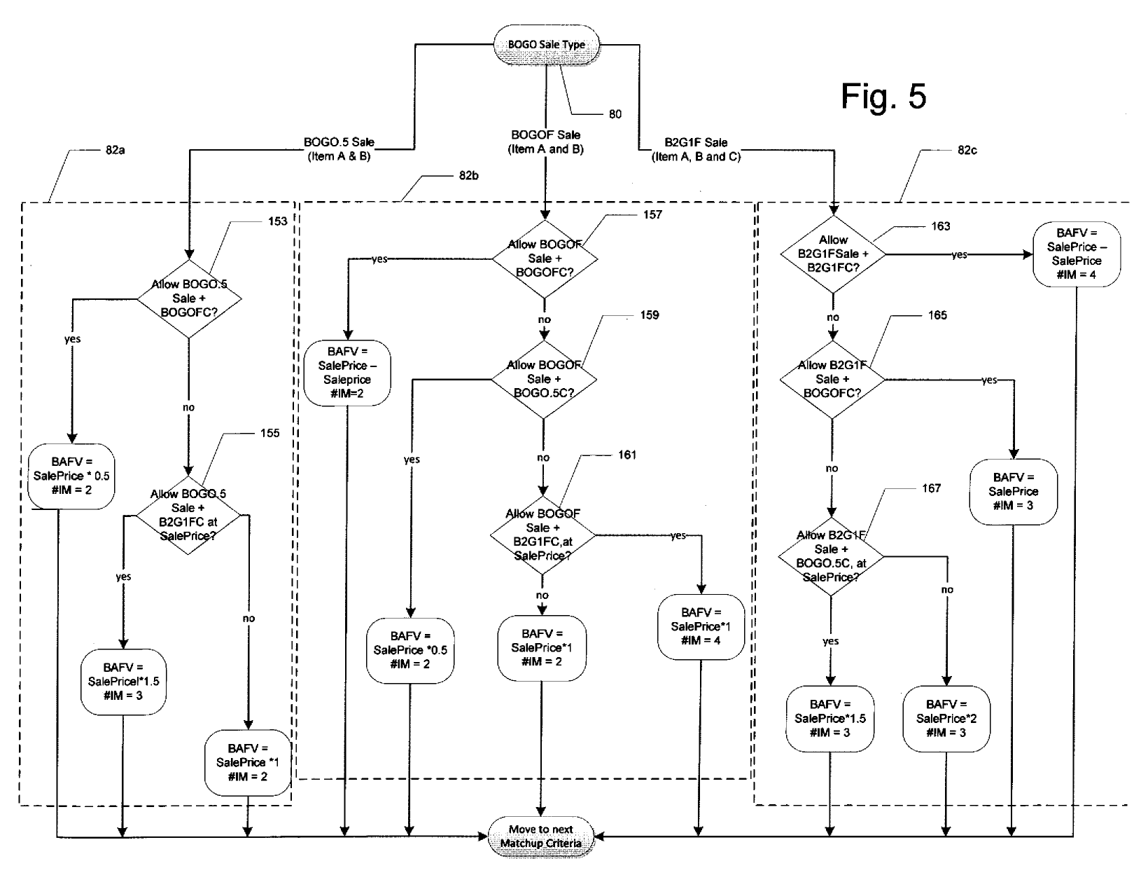

FIG. 5 illustrates the operation of optimization system 10 in executing processes 82a, 82b, 82c, for the cases in which the BOGO sale event is a BOGO.5 sale, a BOGOF sale, and a B2G1F sale, respectively. In process 84, optimization system 10 first identifies the sale price (SLP) of the first item as the original sale price (OSLP), and the SLP of the second item (the one offered for half-price due to the sale), as half the OSLP. From this starting point, process 86 is then executed to determine the nature of the BOGO coupon that was detected in decision 79. Depending on the BOGO offer provided by the coupon (e.g., “buy-one-get-one-at-half-price” coupon (“BOGO.5C”), “buy-one-get-one-free” coupon (“BOGOFC”), or “buy-two-get-one-free” coupon (“B2G1FC”)), optimization system 10 executes the appropriate subpolicy 88a, 88b, 88c.

As shown in the example of FIG. 5, the particular process flow applied to the current matchup depends on the result of process 80, namely the kind of BOGO sale that is the subject of the current matchup. If process 80 identifies the BOGO sale as a BOGO.5 sale (buy-two-get-another-at-half-price), decision 153 is then executed by optimization system 10 to interrogate the applicable coupon policies of the store location in the matchup, to determine whether a BOGOF coupon (“BOGOFC”) can be combined with the BOGO.5 sale. If so (decision 153 is yes), then the BOGO adjusted face value (BAFV) is calculated as one-half the sale price, with the number of items for the matchup (#IM) set to two, corresponding to the required purchase of two items for a total cost of one-half the original price. If not (decision 153 is no), then decision 155 is executed to determine whether the store policy permits combination of a B2G1F (buy-two-get-one-free) coupon with the BOGO.5 sale. If so (decision 155 is yes), optimization system 10 calculates BAFV as 1.5 times the original sales price for one item, and sets #IM to three, corresponding to the required purchase of three items for a total cost of 1.5 times the original price. If not (decision 155 is no), optimization system 10 calculates BAFV as 1.5 times the original sales price for one item, and sets #IM to two, corresponding to the purchase of two items for a cost of 1.5 times the original price (i.e., the BOGO.5 sale without application of the coupon).

For a BOGOF sale (buy-one-get-one-free) identified in process 80, decision 157 is first executed to determine whether the store coupon policy permits use of a BOGOF coupon to the BOGOF sale. If so (decision 157 is yes), the calculated BAFV is set to zero (i.e., the original sale price less the original sale price), and #IM is set to two. If not (decision 157 is no), decision 159 is next executed to determine whether a BOGO.5 coupon can be combined, under the store policy, with the BOGOF sale. If so (decision 159 is yes), optimization system 10 calculates the BAFV as one-half the original sales price, and sets #IM to two, corresponding to the purchase of two items for a total cost of half the original price. If not (decision 159 is no), decision 161 is next executed to determine whether the store coupon policy permits combination of a B2G1F coupon with the BOGOF sale. If so (decision 161 is yes), optimization system 10 calculates BAFV to be the original sales price for one item, for the purchase of four items (#IM=4). If not (decision 161 is no), optimization system 10 sets BAFV to the original sale price and sets #IM to two, corresponding to the purchase of two items for the cost of one, which is the BOGOF sale without the coupon.

For a B2G1F sale (buy-two-get-one-free) identified in process 80, decision 163 is first executed to determine whether the store coupon policy permits use of a B2G1F coupon to the B2G1F sale. If so (decision 163 is yes), optimization system 10 sets BAFV to zero (i.e., the original sale price less the original sale price), and sets #IM to four. If not (decision 163 is no), decision 165 is next executed to determine whether a BOGOF coupon can be combined, under the store policy, with the B2G1F sale. If so (decision 165 is yes), optimization system 10 calculates the BAFV to be the original sales price, and sets #IM to three, corresponding to the purchase of three items for the cost of one. If not (decision 165 is no), decision 167 is next executed to determine whether the store coupon policy permits combination of a BOGO.5 coupon with the B2G1F sale. If so (decision 167 is yes), optimization system 10 calculates BAFV to be 1.5 times the original sales price for one item, for the purchase of three items (#IM=3). If not (decision 167 is no), optimization system 10 sets BAFV to twice the original sale price and sets #IM to three, corresponding to the purchase of three items for the cost of one, which is the B2G1F sale without the coupon.

It is contemplated that variations to the manner in which BOGO sale analysis process 62 is performed according to this embodiment of the invention will be apparent to those skilled in the art having reference to this specification, without undue experimentation. In this regard, other approaches toward managing the use of manufacturer coupons and store coupons on multiple items, if the store is currently offering some type of BOGO sale, are also contemplated, for example replacing decisions 79, 81 and processes 83, 84 of FIG. 4. For example, the type of BOGO coupon may first be determined, followed by interrogation of store policies to determine whether additional manufacturer coupons are allowed on any of the items involved (either on the full price item or on the “get one” items), with the results used to specify the order in which the matchups are defined. It is contemplated that those skilled in the art will be readily able to follow and implement the computer programs appropriate for executing BOGO sale process 62, without undue experimentation.

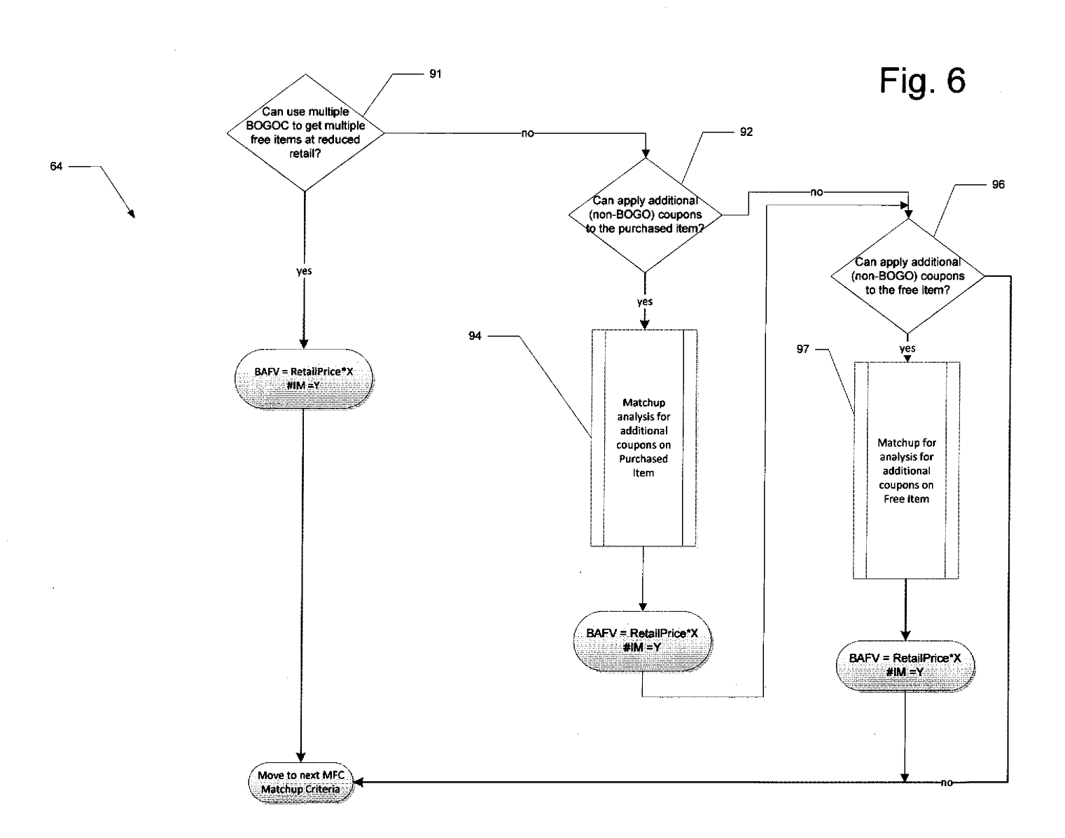

Following the appropriate one of these options, BOGO sale analysis process 62 (FIG. 3) is complete for the particular combination of store and coupon. Optimization system 10 then executes process 64, to evaluate the matchup for no BOGO sale but a BOGO coupon. FIG. 6 illustrates an example of process 64, according to an embodiment of the invention, after the determination that no BOGO sale currently applies to the item at the store of interest, but that a BOGO coupon of some type is in force. In decision 91, optimization system 10 determines whether the applicable store policy allows the use of multiple BOGO coupons to the same items, such that multiple free items can be obtained at reduced price by combining the multiple coupons; for example, two BOGO.5 coupons could be used in combination to purchase three items for the price of two. If so, decision 91 is “yes”, then the BOGO adjusted price BAFV and the number of items required #IM are calculated. If not (decision 91 is “no”), then decision 92 is evaluated by optimization system 10 to determine whether a second, non-BOGO, manufacturer coupon can be applied to the full-price item being purchased under the BOGO coupon. If so (decision 92 is “yes”), analysis process 94 is executed by optimization system 10 to calculate the price paid for the purchased item under the BOGO. For example, the effect of the non-BOGO manufacturer coupon is determined relative to the purchased item with the number of items #IM set to “1” for the first BOGO coupon, and the number of items #IM for the non-BOGO coupon set to “0”. If not (decision 92 is “no”) or upon completion of process 94, optimization system 10 executes decision 96 to evaluate the store policy regarding applicability of a second manufacturer non-BOGO coupon to the free item (i.e., the free or reduced-price item resulting from the first BOGO coupon), considering the effect of any multiplying or upgrading that is in force at the store. If so (decision 96 is “yes”), matchup analysis process 97 is then performed to calculate the effect of the second non-BOGO coupon on the free item from the BOGO coupon, considering the effect of any multiplying or upgrading that is in force at the store; again, the effect of the non-BOGO manufacturer coupon results in the number of items #IM set to “1” for the BOGO coupon, and the number of items #IM for the non-BOGO coupon set to “0”. It is contemplated that those skilled in the art, having reference to this specification, will be readily able to include analysis processes applicable to other sale and coupon situations that may be combined with the BOGO sale or coupon, without undue experimentation.

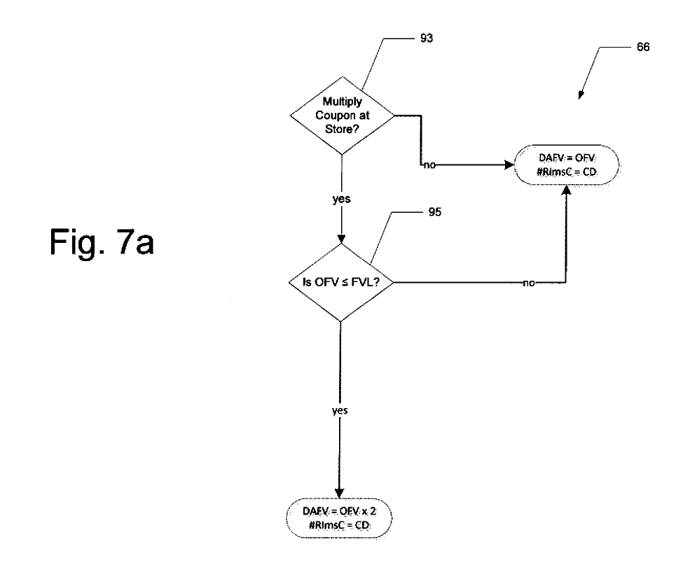

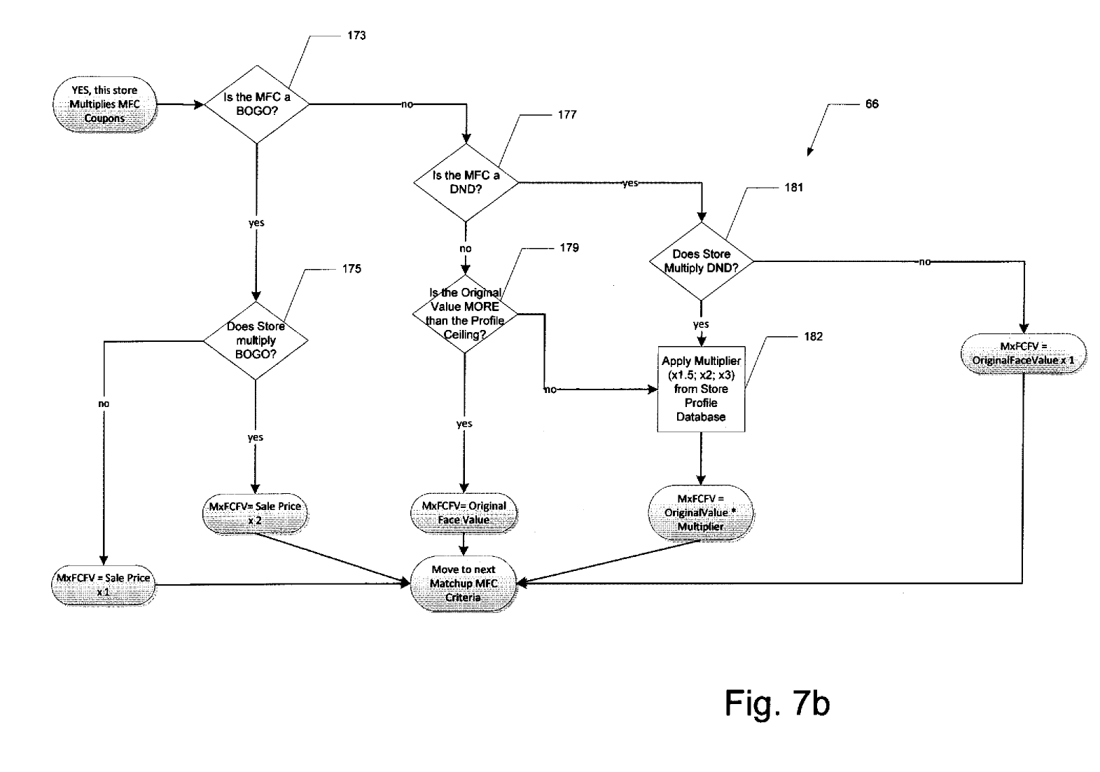

In process 66, matchup process 35 evaluates the multiplying (e.g., doubling or tripling) of manufacturer coupons (MFC) if applied by the particular store involved as either a store policy or a sale event. FIG. 7a illustrates an example of multiply MFC process 66, in which optimization system 10 executes decision 93 to determine whether the store multiplies coupons; if not (decision 93 is “no”), the resulting Double Adjusted Face Value (DAFV) for the coupon is set to its original face value (OFV), and the required number of items (#RimsC) remains the coupon denominator (CD) for the un-doubled coupon. Similarly, if the store multiplies coupons (decision 93 is “yes”) but the coupon original face value is less than or equal to the face value limit (FVL) as determined in decision 95 (with a “no” result), the DAFV is set to OFV and #RimsC is set to CD as before. If the OFV is within the FVL, however (decision 95 is “yes”), the Double Adjusted Face Value (DAFV) coupon is set to twice the OFV (or to such a multiple as indicated by the store policy or sale event), and the required number of items (#RimsC) for is at the coupon denominator (CD).

FIG. 7b illustrates another approach to executing MFC multiplying process 66 according to an embodiment of the invention, incorporating the effect of BOGO events. In decision 173, optimization system 10 determines whether the current manufacturer coupon is a BOGO (buy-one-get-one) coupon of any type. If so (decision 173 is yes), optimization system 10 executes decision 175 to determine, from the store policies, whether the particular store multiplies manufacturer BOGO coupons that are BOGO coupons. If not (decision 175 is no), optimization system 10 calculates the MbFCFV (Manufacturer BOGO Face Value) as the coupon face value price itself (in which case, the BOGO free item is free, as indicated by the coupon). If decision 175 returns a yes result because manufacturer BOGO coupons are doubled, optimization system 10 calculates MbFCFV as twice the coupon face value (i.e., the coupon results in two free items, as being doubled by the store policy). If the coupon is not a BOGO coupon (decision 173 is no), decision 177 is next executed to determine whether the terms of the manufacturer coupon include a prohibition against doubling. If so (decision 177 is yes), decision 181 is next executed to determine whether the store policy doubles “do not double” (DND) coupons anyway. If not (decision 181 is no), optimization system 10 calculates MbFCFV for this coupon as its original face value. If the store does multiple DND coupons (decision 181 is yes), optimization system 10 applies the appropriate multiplier in process 182, and calculates MbFCFV as the original coupon face value times the appropriate store policy multiplier. If the manufacturer coupon is not a DND coupon (decision 177 is no), decision 179 is executed to determine whether the face value of the coupon exceeds a “ceiling” maximum coupon value for multiplying, as indicated by the store profile database entry for this store. If the original coupon face value exceeds the ceiling value (decision 179 is yes), no multiplier is applied to the coupon, and optimization system 10 sets MbFCFV as the original coupon face value. If the ceiling is not exceeded by the coupon face value (decision 179 is no), the appropriate multiplier is applied to the face value in process 182, and optimization system 10 calculates MbFCFV as the original coupon face value times the appropriate store policy multiplier. It is contemplated that those skilled in the art will be readily able to implement variations and alternatives in the computer programs for executing the flow diagram of FIG. 7b, without undue experimentation. In this implementation, optimization system 10 determines MbFCFV and M#R, as noted above.

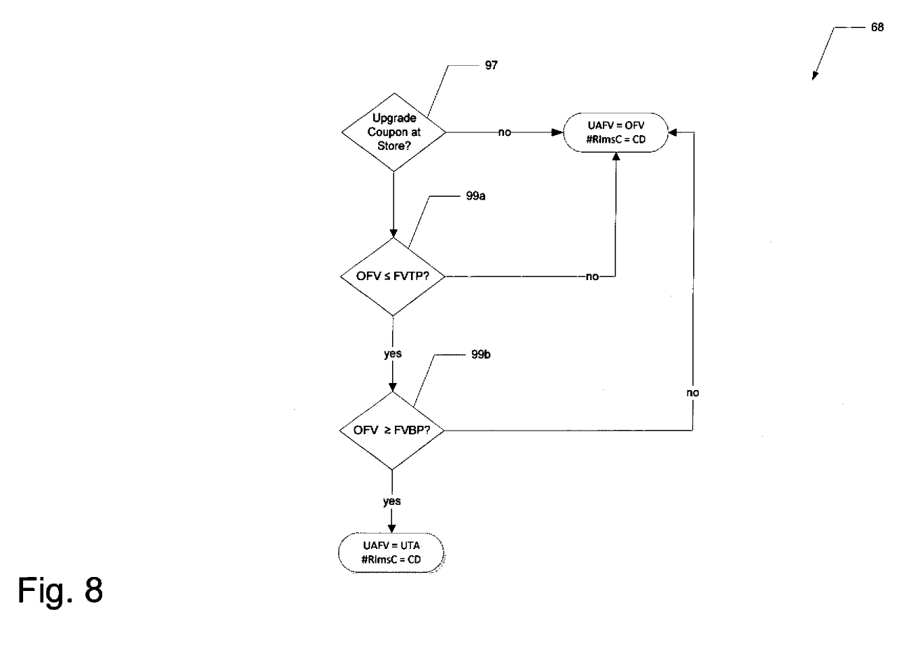

In process 68, matchup process 35 (FIG. 3) applies any upgrading of MFCs according to the current store policy or sale event, to arrive at an Upgrade Adjusted Face Value (UAFV) and required number of items (#RimsC) for the coupon being upgraded. As known in the art, coupon upgrading at a store refers to increasing of the coupon face value for a number of items. FIG. 8 illustrates an example of upgrade MFC process 68, in which optimization system 10 executes a series of decisions 97, 99a, 99b. Decision 97 determines whether the store policy or current sale event upgrades MFCs, while decision 99a, 99b determine whether the coupon face value is below and above the Face Value Top Parameter (FVTP) and Face Value Bottom Parameter (FVBP), respectively. If any of decisions 97, 99a, 99b returns a “no” result, then the Upgrade Adjusted Face Value (UAFV) for the coupon is set to the original face value (OFV), and the required number of items (#RimsC) for the coupon remains the coupon denominator (CD) for that un-upgraded coupon. If all three criteria are met (decisions 97, 99a, 99b are all “yes”), then the coupon Upgrade Adjusted Face Value is upgraded to the Upgrade Total Amount (UTA), and #RimsC is set to CD.

Other approaches to executing MFC upgrade process 68 can incorporate the effect of upgrading BOGO coupons, when permitted by the store policy allows. It is contemplated that those skilled in the art having reference to this description will be readily able to adapt the flow diagram of FIG. 8 to accommodate such alternative features and implementations, such as contemplating upgraded BOGO coupons, without undue experimentation.

In processes 70, 72 of matchup process 35 (FIG. 3), optimization system 10 applies store multiplying and upgrading to store coupons (STC), in similar manner as described above for manufacturer coupons (MFC). Matchup processes 35 then interrogates the store policy or sale event to determine whether the store accepts competitor store coupons, and if so, processes matchups for those competitor coupons in process 74. Process 74 is applied in much the same manner as described above for BOGO, multiply, and upgrade of store coupons issued by the store of interest.

To complete matchup process 35 for the current coupon as applied to the store of interest, optimization system 10 executes process 76 to determine the number of items required for the identified matchup of coupon-to-store, after analysis of the BOGO, multiply, upgrade and other criteria, sequentially and in combination. And in process 78, optimization system 10 calculates the out of pocket cost to the subscriber if the subscriber chooses to purchase the number of items for the matchup, applying the particular coupon, all in light of the store policy and current sale event. The resulting matchup identified by this instance of matchup process 35 is then stored in a memory resource of optimization system 10.

As shown in FIG. 3 and as mentioned above, matchup process 35 is applied to each possible matchup of a coupon with a particular store of interest, applying the current store policies and according to any operative sale events occurring within the time being analyzed. As such, matchup process 35 is iterated over each of those coupons and stores, to build up a list of currently operative matchups of coupon and store sales/policies for each particular item under analysis. As described above in connection with FIG. 2, optimization system 10 then presents these matchups to the subscribers in process 36, by way of a graphics display at the particular client system 12, 14, 16, or in the alternative or in addition, by way of a printed hard copy, email or other such medium.

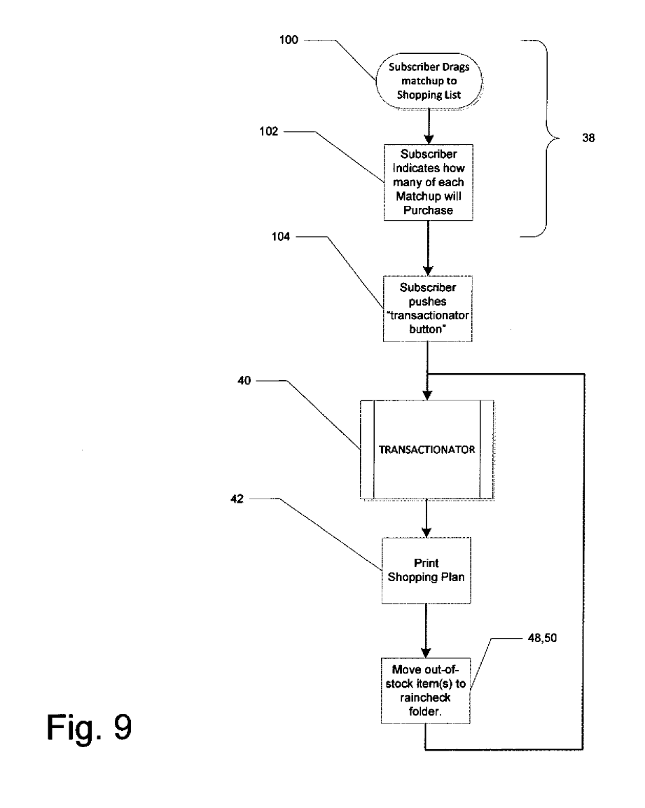

As discussed above, a subscriber that is logged into optimization system 10 can thus be made aware of current matchups for particular products for which manufacturer or store coupons are current available and operative. In process 38, the subscriber provides shopping list inputs to optimization system 10, to provide a criterion by way of which certain matchups can be gathered for further consideration by optimization system 10. According to embodiments of this invention, these shopping list inputs can be provided by the subscriber selecting, from this displayed matchup list, individual matchups that pertain to an item sought to be purchased by the subscriber, and for which the subscriber is in possession of the corresponding coupon. As mentioned above, the selection of process 38 can be interactively made in any number of ways, including by “drag-and-drop”, clicking selection boxes, links, or icons, and the like. In any event, selection process 38 is intended to identify, to optimization system 10, those matchups that the subscriber wishes to arrange into a transaction plan. For example, as shown in FIG. 9, selection process 38 may be carried out by the subscriber dragging the desired matchups to a “shopping list” displayed at the operative client system 12, 14, 16 in process 100, followed by the subscriber indicating via that client system 12, 14, 16 how many items he or she intends to purchase, in process 102. Alternatively, the subscriber can provide shopping list inputs to optimization system 10 in the form of a spending limit (in dollars) at a particular store, along with the types of items that the customer wishes to purchase at that store, within the shopping limit, at the best value. Other alternative criteria for selecting matchups from the displayed matchup list are also contemplated.

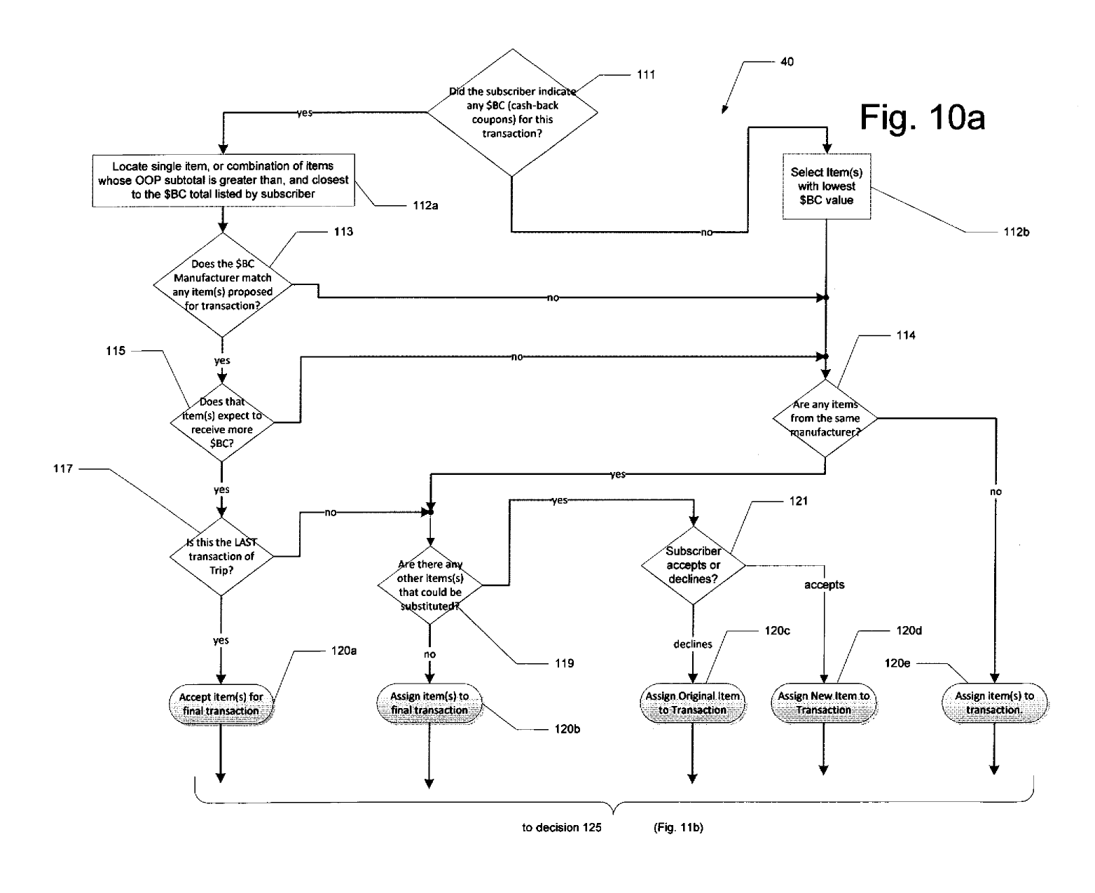

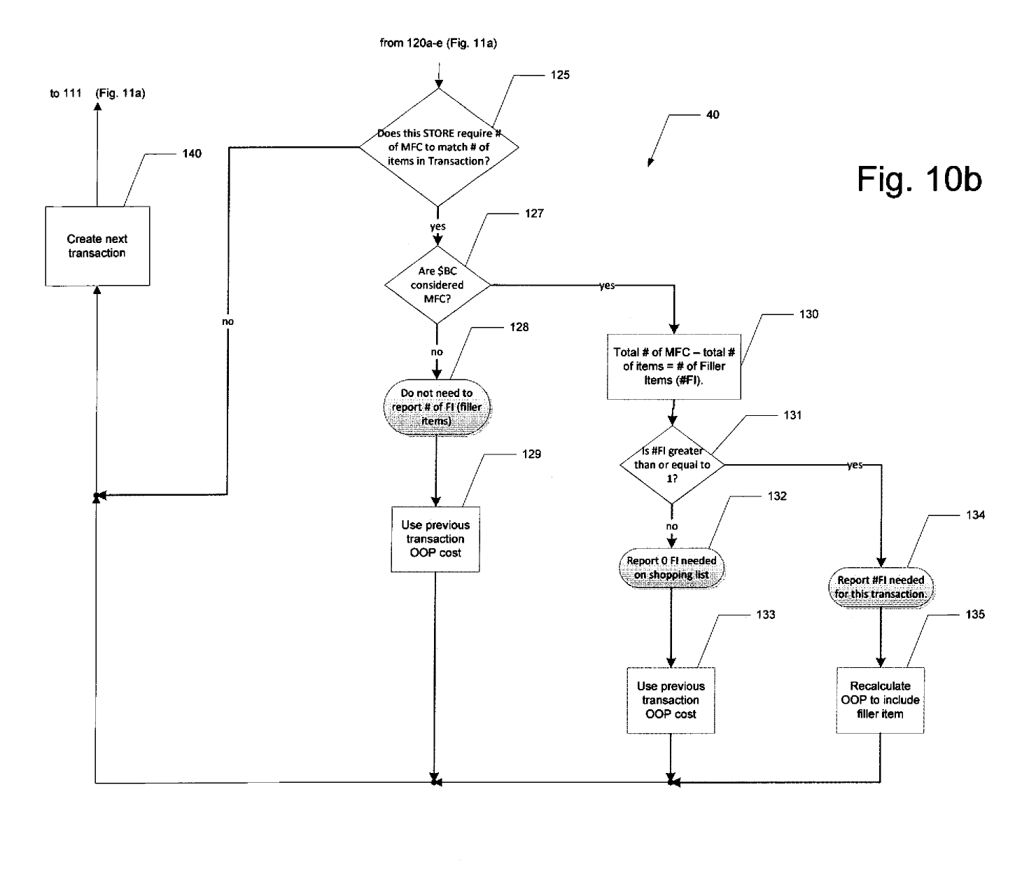

Upon completion of processes 100, 102 for all desired items that are associated with matchups, the subscriber initiates execution of transactionator process 40, by clicking or otherwise selecting a “transactionator button” displayed at the operative client system 12, 14, 16, in process 104. Transactionator process 30 arranges items to be purchased at a particular store location into “transactions” (i.e., groups of items to be purchased at one time, each transaction being paid for by its own individual payment) in order to optimize a benefit value to the subscriber in purchasing the items defined by the shopping list inputs. The subscriber may carry out multiple transactions during a single shopping trip to the store location. Some stores may require the subscriber to leave the store (e.g., take the purchased goods to a parked vehicle) between each transaction; other stores may allow a customer to purchase items in multiple sequential transactions while at the cashier station. For the case in which specific items with coupons are selected by the subscriber for purchase in process 38, the optimization of the benefit value by transactionator process 40 is the minimization of the out-of-pocket cost to the subscriber. Other benefit values that may alternatively be optimized in the arranging of transactions by transactionator process 40 include the maximizing of savings for a selected number of items; if the shopping list inputs from the subscriber applied in process 38 is a spending limit with types of items to purchase, the optimized benefit value can be the maximized retail value of the items of the desired types that can be purchased within the specified spending limit. Transactionator process 40 is then executed by optimization system 10, as will now be described in further detail in connection with FIGS. 10a and 10b.

This description of transactionator process 40 in connection with the example of FIGS. 10a and 10b assumes that the subscriber has selected several matchups (i.e., item/coupon/store matchups identified by matchup process 35) for a “shopping list” maintained by client system 12, 14, 16 (in process 100), that the subscriber has also indicated how many of each matchup item he or she is planning on purchasing (process 102), and that the selected benefit value to be optimized is the minimization of out-of-pocket cost. This description also assumes that the subscriber is making use of a “rain check” tracking function, as will be described below.

In some cases, certain “cash back rules” may be enforced by the store, as indicated in the store profile maintained and retrieved by optimization system 10. In many stores, reward coupons ($BC) refer to the amount of store credit (expressed in dollars or points) that a customer can earn by purchasing the particular item specified in the coupon or sale. To control the extent to which customers can amass cash back rewards by purchasing extraordinary numbers of items, the “cash back rules” enforced by the retail stores limit the extent to which those rewards can be earned. For example, some store rules refer to the sponsoring manufacturer for the reward coupon to impose a limit on the reward value earned to one reward per transaction for items from that manufacturer (i.e., a second item from the same manufacturer in the same transaction will not earn a reward). Other stores impose reward limits based on a “club card” that identifies each particular shopper participating in the reward program; in this case, the particular rewards club program may have a set of rules limiting the reward amount earned by a particular customer per transaction. These rules are incorporated into the arranging of matchup items into transactions carried out in transactionator process 40. FIGS. 10a and 10b illustrate the example in which the reward, in the form of cash back, is limited to one reward per manufacturer per transaction.

Transactionator process 40 begins with decision 111, in which optimization system 10 determines whether the subscriber indicated that cash-back coupons ($BC) from a previous shopping trip (e.g., as entered by the subscriber prior to pressing the “transactionator button” in process 104) are applicable to the shopping transaction. If so (decision 111 is “yes”), then optimization system 10 locates one or a combination of items from the shopping list for which the out-of-pocket cost (“OOP”) is greater than, but closest to, the cash-back total indicated by the left-over $BC, in process 112a. In this situation, the goal of transactionator process 40 is to arrive at an out-of-pocket cost (OOP) that is equal to, or at least close to, the remaining cash-back amount retained by the customer, as well as to maximize the new cash back being earned during this shopping trip. Assuming that the subscriber has indicated “roll” in his or her profile data, the new cash back earned in one transaction can then be applied to the next transaction in the same shopping trip, again with an eye toward minimizing the OOP required in excess of the current cash back amount. To accomplish this in the example of FIGS. 10a and 10b, optimization system 10 determines in decision 113 whether the manufacturer offering the cash-back coupon matches any of the items in the current transaction; if so (decision 113 is “yes”), then decision 115 is executed to determine whether additional $BC are expected for that item. If so (decision 115 is “yes”), then decision 117 is executed to determine whether this if the last transaction of the trip; if so (decision 117 is “yes”), the item is accepted for the final transaction in process 120a. If not (decision 117 is “no”), control passes to decision 119 as will be described below.

If either of decisions 113 or 115 return a “no” result, control passes to decision 114. In addition, if decision 111 returns a no result, indicating that there are no cashback coupons for this transaction, optimization system 10 executes process 112b to select items from the shopping list that have the lowest $BC value. Decision 114 then (in any of these three cases) determines whether any of the identified items are from the same manufacturer (applicable to those stores that limit the earning of cash back rewards to one item per transaction from the manufacturer sponsoring the coupon). If not (decision 114 is “no”), the item or items are assigned to the current transaction in process 120e. If so (decision 114 is “yes”), decision 119 determines whether any other items could be substituted for the currently selected items (from process 112a or 112b), to allow additional cash back to be earned in this transaction. If not (decision 119 is “no”), then those items are assigned to the final one of the transactions to be carried out in this shopping trip. If so (decision 119 is “yes”), the subscriber is presented with the option of whether to accept or decline the substitute items; the response from the subscriber is interrogated by optimization system 10 in process 121. If the substitute item is accepted (decision 121 is “accepts”), the new item is assigned to the current transaction under consideration, in process 120d. If declined (decision 121 is “declines”), the original item is assigned to the transaction in process 120c. Regardless of the applicable path, this portion of transactionator process 40 assigns one or more items to a current transaction (120c, 120d, 120e), or to a final transaction (120a, 120b), for the subscriber's shopping trip to the store of interest.

In any case, once an item is assigned to a transaction (processes 120a through 120e), decision 125 (FIG. 10b) is then executed by optimization system 10 to determine whether the current store of interest requires the number of items purchased in the transaction to match the number of items required by the manufacturer coupons (MFCs) to be applied to that transaction. Typically, the number of items required to be purchased is the sum of the number of items specified by the coupons (e.g., two items are required if the coupon is for “$1 off of 2”) plus the number of cash back coupons used to pay for the transaction. If not (decision 125 is “no”), then the current transaction can be considered complete, and a new transaction is created in process 140, followed by control passing back to decision 111 (FIG. 10a) for the assignment of new items to this new transaction. On the other hand, if decision 125 returns a “yes” result, decision 127 then determines whether cash-back coupons ($BC) are considered as MFCs for this purpose. If not (decision 127 is “no”), no “filler items” are required in order to meet the store's transaction rules, and as such a null result for the number of filler items #FI is assigned in process 128, and the previously determined OOP cost for this transaction is applied to the transaction in process 129. The next transaction can then be created in process 140, followed by assignment of items to transactions beginning again with decision 111 (FIG. 10a).

If $BC are considered as MFCs by the store (decision 127), then the number of filler items (#FI) is calculated by optimization system 10 in process 130, as the total number of items required by the coupons being applied less the number of items currently in the transaction. If one or more filler items are required (decision 131 returns a “yes”), that number #FI is reported in process 134, and the OOP cost is recalculated to include those filler items. If no filler items are required (decision 131 returns a “no”), then #FI is set to zero in process 132, and the previously calculated OOP cost for the transaction is applied in process 133. In either case, following process 133 or 135, as the case may be, a new transaction is created in process 140, followed by assignment of items to transactions beginning again with decision 111 (FIG. 10a).

Upon completion of transactionator process 40 in this manner, through its multiple iterations, the subscriber will be presented with a shopping plan for the visit to the store of interest. That shopping plan will include a list of which items to buy in each of one or more transactions, with those transactions arranged in order to minimize the out-of-pocket cost (OOP). Alternatively, as mentioned above, the transactions may be arranged by transactionator process 40 to maximize the savings, without strict regard to minimizing out-of-pocket cost (although out-of-pocket cost will generally fall as savings increase). If the selected benefit value is maximized savings, optimization system 10 may further analyze the identified matchups for that retail store, and suggest to the subscriber additional items not on his or her shopping list that would provide additional savings relative to retail, considering the transactions already generated by transactionator process 40. If the subscriber interactively chooses to pursue those additional items, optimization system 10 could perform transactionator process 40 again to rearrange the items and transactions to attain those increased savings using the suggested items. If multiple transactions are specified (i.e., with cash back or a store coupon being awarded in one transaction, for use in a subsequent transaction), then the shopping plan output by transactionator process 40 will indicate the sequence of transactions to be executed. That shopping plan is printed or displayed to the subscriber in process 42. And, as described above in connection with FIG. 2, if a particular item on the shopping plan is out of stock at the store, processes 48, 50 can save those items in a “rain check” folder (with the appropriate rain check issued by the store in that event), and transactionator process 40 can be then repeated, comprehending the out-of-stock condition. Conversely, items that were previously in the rain check folder for the subscriber can be applied to transactionator process 40, so that the shopping plan generated can include those rain check items for which coupons may otherwise be expired.

If the cash back limit applied by the retail store is a “card based” limit, in which the cash back reward that a customer can earn, for example for the duration of a particular sale event, is enforced by reference to the customer's reward card identification, the process described above relative to FIGS. 10a and 10b would be altered to apply that card-based limit rather than the manufacturer-based limit, for example by changing decision 114 accordingly to determine whether to add an item to a current transaction or the final transaction of the shopping trip.

In a more general sense, the particular sequence in which the various considerations of transactionator process 40 are evaluated is not of particular concern, and as such transactionator process 40 is described above in connection with FIGS. 10a and 10b by way of example only. Those skilled in the art having reference to this specification can arrange the sequence of processes and decisions in a number of ways to accomplish the same analysis. Typically, it is contemplated that, for purposes of earning and applying cash back rewards, transactionator process 40 will apply certain types of rules in some order:
If rewards or coupons are to be used to purchase products in a transaction, the total combined out-of-pocket cost of the items in the transaction must be greater than or equal to the dollar amount of the reward (e.g., cash or points) to be used to purchase those products.
For stores that enforce reward coupon limits by manufacturer (e.g., only one item per transaction from the manufacturer sponsoring the coupon can earn a reward), the manufacturer of items purchased that are to earn a reward in the transaction cannot be the same as the manufacturer sponsoring the reward coupon that is being applied to pay for that transaction.
For stores that enforce reward coupon reward limits by manufacturer, no more than one item from a single manufacturer can earn rewards in the same transaction.
For stores that enforce reward coupons by way of a store reward card, the reward earned in a transaction cannot exceed the reward limit for that reward card for that customer.
For stores that require the count of items purchased in a transaction to equal (or exceed) the number of items required by the coupons being used for that transaction, filler items must be added to the transaction; optimization system 10 should calculate the number of filler items required in carrying out transactionator process 40. Reward coupons are often considered as manufacturer coupons.
Transaction coupon (e.g., $20 off of purchases exceeding $100) requirements must be compared against the transaction to determine whether the transaction qualifies for the coupon, or if instead the coupon is to be “rainchecked”.
Results are returned to the subscriber based on subscriber preferences (e.g., roll vs. no-roll), including the selected benefit value (e.g., lowest out-of-pocket cost or greatest savings).

It is contemplated that those skilled in the art having reference to this specification may implement these and other additional and alternative rules into optimization systems carrying out the transactionator process, within the scope of this invention.

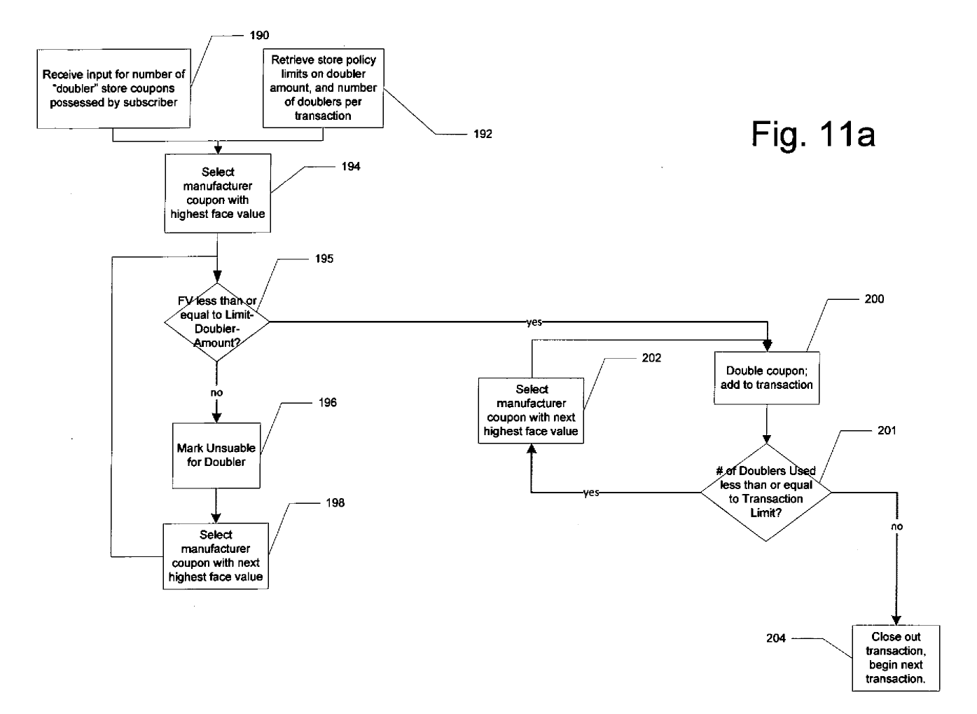

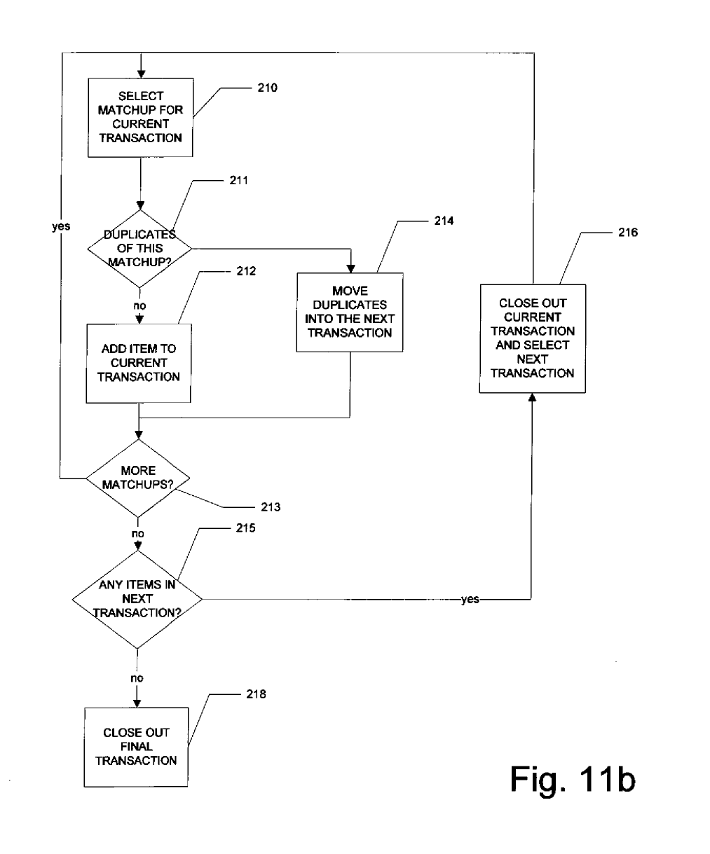

Other variations can be incorporated into transactionator process 40 as executed by optimization system 10. FIGS. 11a and 11b illustrate these variations in connection with coupon-based or store-based “doubling” of coupon values. It is contemplated that those skilled in the art will be readily able to follow and implement the computer programs appropriate for executing the flow diagram of FIGS. 11a and 11b, without undue experimentation.

FIG. 11a illustrates the operation of transactionator process 40 for the case in which the store of interest uses “doubler” coupons. Such doubler coupons double the face value of manufacturer coupons, and as such can significantly affect the transaction strategy. The arrangement of transactions by transactionator process 40 in this event is contemplated by the process of FIG. 11a. In process 190, optimization system 10 receives inputs from the subscriber for the number of “doubler” coupons in the subscriber's possession for that store, and in process 192, optimization system 10 retrieves, from store profile database 28, the applicable store policies regarding limits on the dollar amount of a coupon that can be doubled and on the number of doubled coupons in a single transaction. In process 194, optimization system 10 selects the coupon with the highest face value, and compares that face value against the store coupon policy dollar limit on doubling, in decision 195. If the coupon face value is higher than the limit (decision 195 is no), the coupon is marked as unusable for doubling in process 196, the next highest face value coupon is selected in process 198, and decision 195 is repeated for that next coupon. Upon detecting the highest value coupon that is less than or equal to the doubling limit (decision 195 is “yes”), that coupon is then considered as doubled in process 200 of transactionator process 40. Decision 201 determines whether the number of doubler coupons used is below the store policy limit for a single transaction; if so (decision 201 is “yes”), the next highest face value is selected in process 202, and that coupon is again doubled in process 200 and decision 201 is repeated. Upon reaching the transaction limit on doubling (decision 201 is “no”), optimization system 10 closes out the transaction in process 204, at least from a doubling standpoint.

Various alternatives to this doubling scheme are also contemplated for inclusion into transactionator process 40. For example, the process of FIG. 11b as executed by optimization system 10 considers the store policy in which a special store coupon is not required for doubling, but in which coupon doubles are limited to one per transaction. In process 210, transactionator process 40 begins with selecting a matchup for consideration in a current transaction. Decision 211 determines whether duplicates of that matchup are present in the shopping list; if so (decision 211 is “yes”), those duplicates are moved into a next transaction. If not (decision 211 is “no”), the item corresponding to that matchup is moved into the current transaction. Decision 213 determines whether additional matchups in the shopping list remain to be analyzed; if so (decision 213 is “yes”), the process is repeated with the selection of a next matchup in process 210. If no more matchups remain to be analyzed (decision 213 is “no”), decision 215 is executed to determine whether duplicate items have been moved into the next transaction. If so (decision 215 is “yes”), the current transaction is closed, and a next transaction is selected for analysis; the process then repeats from process 210 as for the prior transaction. If no duplicates were moved into a next transaction from the current transaction (decision 215 is “no”), the current transaction is closed out as the final transaction for this shopping trip.

As discussed above in connection with FIG. 2, upon completion of transactionator process 40, optimization system 10 outputs the identified transactions to the subscriber in process 42 for use in planning a shopping trip to the retail store. Process 42 may be carried out by displaying the transaction plan on the subscriber's smartphone, or in a printable form at a workstation or personal computer, or the like, depending on the particular client system 12, 14, 16 through which the subscriber is logged in to optimization system 10. The subscriber is then ready to go to the retail store, whether physically or online, shop for the identified items according to the transactions generated as a result of transactionator process 40, preferably in an interactive manner to enable tracking of savings (process 49), acquiring of rainchecks for out-of-stock items (decision 48), purchasing substitute items (process 50) and repeating transactionator process 40, and the other operations described above in connection with FIG. 2, according to embodiments of this invention.

Of course, additional variations and situations applicable to the tactics involved in maximizing savings and minimizing out of pocket cost, by structuring multiple transactions in a given shopping trip, may additionally or alternatively be implemented within transactionator process 40. It is contemplated that those skilled in the art will be readily able to implement computer programs appropriate for executing those particular variations and alternatives, without undue experimentation.

According to the embodiments of the invention described herein, it is contemplated that an automated optimization system and method is provided by way of which a shopper can identify current or future combinations of coupons, store sale events, cash back and other reward programs, and the like, and obtain a shopping strategy for maximizing the benefits available from those coupons, events, programs, etc. In particular, the automated structure and operation of the system and method according to embodiments of this invention provides a computerized system, including software resources in one or more various forms such as conventional personal computer applications, web applications, and tablet/smartphone “app”, operates to configure and customize shopping transactions based on subscriber selections, current store policies, and current coupon terms. Such a system and method, according to embodiments of this invention, are contemplated to save shoppers significant time and effort in such strategization, enabling additional savings opportunities at a wide range of retail stores and events.

While this invention has been described according to its embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention.

What is claimed is:

1. A method of operating a computer system to produce a suggested list of items to be purchased in one or more transactions at a retail store, comprising the steps of:
storing, in a subscriber profile database in a memory resource of the computer system, data identifying retail stores preferred by each of a plurality of subscribers;
storing, in a store profile database in a memory resource of the computer system, data identifying a location of each of a plurality of retail stores, and, for each of the plurality of retail stores, data identifying one or more coupon policies at that retail store;
storing, in a coupon profile database in a memory resource of the computer system, for each of a plurality of coupons, data identifying an item associated with the coupon, and data identifying coupon attributes comprising face value and expiration date;
storing, in a sale profile database in a memory resource of the computer system, for each of a plurality of sale events, data identifying sale attributes comprising retail store locations associated with the sale event, a sale item associated with the sale event, and a sale price for the sale item;
for each of one or more subscribers, operating the computer system to match coupons with sale items, at the plurality of retail stores;
displaying to a subscriber, a matchup list of one or more items at one or more retail stores preferred by that subscriber, the matchup list including coupons currently in force for the item, sale events associated with that item at one or more preferred retail stores, and any coupon policies associated with the coupons at those preferred retail stores;
receiving, from the subscriber, shopping list inputs selecting one or more of the items in the matchup list; and
responsive to the shopping list inputs, operating the computer system to arrange the selected items into one or more transactions, each transaction associated with one of the preferred retail stores for the subscriber, and arranged to optimize a benefit value for the items based on coupons current in force for the selected items, sale events associated with the selected items, and coupon policies associated with the coupons at the preferred retail store.

2. The method of claim 1, wherein the optimized benefit value is minimum out-of-pocket cost.

3. The method of claim 2, wherein the coupon attributes further comprise reward value;
wherein the data identifying one or more coupon policies at a retail store comprises data identifying one or more reward rules;
and wherein the step of operating the computer system to arrange the selected items into one or more transactions comprises:
responsive to the subscriber indicating possession of cash back coupons for the retail store, selecting those one or more selected items for a transaction having an out-of-pocket cost greater than but closest to the reward value of the cash back coupons possessed by the subscriber.

4. The method of claim 1, wherein the optimized benefit value is maximum savings.

5. The method of claim 4, further comprising:
after the step of operating the computer system to arrange the selected items into one or more transactions, operating the computer system to identify additional suggested items to be purchased by the subscriber at the retail store that further increase savings.

6. The method of claim 1, wherein the coupon attributes further comprise a required number of items to be purchased from a manufacturer;
wherein the data identifying one or more coupon policies at a retail store comprises data identifying whether the retail store requires the required number of items of the coupon attribute to match the number of items in a transaction at the retail store;
and wherein the step of operating the computer system to arrange the selected items into one or more transactions comprises:
assigning one or more selected items to a transaction;
responsive to the retail store requiring that the required number of items of the coupon attribute to match the number of items in a transaction at the retail store, selecting one or more filler items to be added to the transaction; and
calculating the out-of-pocket cost of the transaction including the filler items.

7. The method of claim 1, wherein the shopping list inputs comprise:
selected types of items to be purchased at the retail store; and
a spending limit for the subscriber at the retail store;
and wherein the optimized benefit value is a maximum retail value of selected items within the spending limit.

8. The method of claim 1, wherein the coupon attributes further comprise one or more attributes selected from the group consisting of:
manufacturer of the item;
brand of the item;
sub-brand of the item;
variety of the item; and
size of the item.

9. The method of claim 1, further comprising:
updating data identifying one or more coupon policies in the stored profile database for one or more retail stores; and
repeating the step of operating the computer system to match coupons with sale items.

10. The method of claim 1, wherein the displaying step also displays, to the subscriber, all applicable coupons for each of a plurality of items at a preferred retail store.

11. The method of claim 10, further comprising:
receiving inputs from the customer identifying a coupon for which coupon attributes are not stored in the coupon database, and coupon attributes of the identified coupon; and
repeating the step of operating the computer system to match coupons with sale items at preferred retail stores, using the identified coupon in combination with coupons for which coupon attributes are stored in the coupon database.

12. The method of claim 1, further comprising:
receiving an input from the subscriber indicating issuance of a raincheck for a sale item at a preferred retail store, the raincheck indicating that one of the selected items arranged in one of the transactions is unavailable for purchase;
storing, in the subscriber profile database, data identifying the issued raincheck, the raincheck data including attributes corresponding to a preferred retail store, an item, and an adjusted retail price for the item;
and further comprising:
repeating the step of operating the computer system to arrange the selected items into one or more transactions, excluding the item that is unavailable for purchase.

13. An optimization computer system for producing a suggested list of items to be purchased in one or more transactions at a retail store, comprising:
one or more processing units for executing program instructions;
one or more memory resources, coupled to the one or more processing units, for storing:
a subscriber profile database containing data identifying retail stores preferred by each of a plurality of subscribers;
a store profile database containing data identifying a location of each of a plurality of retail stores, and containing, for each of the plurality of retail stores, data identifying one or more coupon policies at that retail store;
a coupon profile database containing, for each of a plurality of coupons, data identifying an item associated with the coupon, and containing data identifying coupon attributes comprising face value and expiration date; and
a sale profile database containing, for each of a plurality of sale events, data identifying sale attributes comprising retail store locations associated with the sale event, a sale item associated with the sale event, and a sale price for the sale item;
program memory, coupled to the one or more processing units, for storing a computer program including program instructions that, when executed by the one or more processing units, causes the optimization computer system to perform a sequence of operations comprising:
matching coupons with sale items at each of the plurality of retail stores;
displaying, to a subscriber, a matchup list of one or more items at one or more retail stores preferred by that subscriber, the matchup list including coupons currently in force for the item, sale events associated with that item at one or more preferred retail stores, and any coupon policies associated with the coupons at those preferred retail stores;
receiving, from the subscriber, shopping list inputs selecting one or more of the items in the matchup list; and
responsive to the shopping list inputs, operating the one or more processing units to arrange the selected items into one or more transactions, each transaction associated with one of the preferred retail stores for the subscriber, and arranged to optimize a benefit value for the items based on coupons current in force for the selected items, sale events associated with the selected items, and coupon policies associated with the coupons at the preferred retail store.

14. The system of claim 13, wherein one of the processing units comprises a client station;
and wherein the displaying and receiving operations are executed at the client station.

15. The system of claim 14, wherein another one of the processing units comprises a server, coupled to the client station over a network;
and wherein the matching operation and the operation of operating the one or more processing units to arrange the selected items into one or more transactions are executed at the server.

16. The system of claim 13, wherein the optimized benefit value is minimum out-of-pocket cost;
wherein the coupon attributes further comprise reward value;
wherein the data identifying one or more coupon policies at a retail store comprises data identifying one or more reward rules;
and wherein the operation of operating the computer system to arrange the selected items into one or more transactions comprises:
responsive to the subscriber indicating possession of reward coupons for the retail store, selecting those one or more selected items for a transaction having an out-of-pocket cost greater than but closest to the reward value of the reward coupons possessed by the subscriber.

17. The system of claim 13, wherein the optimized benefit value is maximum savings;
and wherein the sequence of operations further comprises:
after the operation of operating the one or more processing units to arrange the selected items into one or more transactions, operating the one or more processing units to identify additional suggested items to be purchased by the subscriber at the retail store that further increase savings.

18. The system of claim 13, wherein the shopping list inputs comprise:
selected types of items to be purchased at the retail store; and
a spending limit for the subscriber at the retail store;
and wherein the optimized benefit value is a maximum retail value of selected items within the spending limit.

19. A non-transitory computer-readable medium storing a computer program that, when executed on a computer system, causes the computer system to perform a sequence of operations for producing a suggested list of items to be purchased in one or more transactions at a retail store, the sequence of operations comprising:
storing, in a subscriber profile database, data identifying retail stores preferred by each of a plurality of subscribers;
storing, in a store profile database, data identifying a location of each of a plurality of retail stores, and containing, for each of the plurality of retail stores, data identifying one or more coupon policies at that retail store;
storing, in a coupon profile database, and for each of a plurality of coupons, data identifying an item associated with the coupon, and containing data identifying coupon attributes comprising face value and expiration date; and
storing, in a sale profile database, and for each of a plurality of sale events, data identifying sale attributes comprising retail store locations associated with the sale event, a sale item associated with the sale event, and a sale price for the sale item;
matching coupons with sale items at each of the plurality of retail stores;
displaying, to a subscriber, a matchup list of one or more items at one or more retail stores preferred by that subscriber, the matchup list including coupons currently in force for the item, sale events associated with that item at one or more preferred retail stores, and any coupon policies associated with the coupons at those preferred retail stores;
receiving, from the subscriber, shopping list inputs selecting one or more of the items in the matchup list; and
responsive to the shopping list inputs, arranging the selected items into one or more transactions, each transaction associated with one of the preferred retail stores for the subscriber, and arranged to optimize a benefit value for the items based on coupons current in force for the selected items, sale events associated with the selected items, and coupon policies associated with the coupons at the preferred retail store.

20. The computer-readable medium of claim 19, wherein the benefit value is selected from the group consisting of minimum out-of-pocket cost, maximum savings, and a maximum retail value of selected items within a subscriber-defined spending limit.
